(19) United States
(12) Patent Application Publication
(10) Pub. No.: US 2026/0151868 A1
(43) Pub. Date: Jun. 4, 2026

(54) REMNANT EXTRACTION TOOLS, ROBOTIC MANUFACTURING SYSTEMS AND METHODS FOR EXTRACTING REMNANTS DURING DRILLING OPERATIONS AT ROBOTIC MANUFACTURING SYSTEMS

(71) Applicant: The Boeing Company, Arlington, VA (US)

(72) Inventors: Voltaire F. Valeriano, Jr., Lynnwood, WA (US); Paul C. Chang, Arlington, WA (US)

(73) Assignee: The Boeing Company, Arlington, VA (US)

(21) Appl. No.: 18/968,362

(22) Filed: Dec. 4, 2024

(51) Int. Cl. B23Q 11/00; B25J 11/00; B64F 5/10

(52) U.S. Cl. CPC B23Q 11/0046; B25J 11/005; B64F 5/10

(57) ABSTRACT

A remnant extraction tool includes a nosepiece assembly and a vacuum assembly. The nosepiece assembly engages with a robotic manipulator to adjustably align with an exit side of a workpiece during a drilling operation through the workpiece at a predetermined location. The drilling operation includes drilling performed by another robotic manipulator from a drilling side of the workpiece. The vacuum assembly is in fluidic communication with the nosepiece assembly and engages with the robotic manipulator to selectively apply a vacuum to the exit side of the workpiece via the nosepiece assembly and to collect remnants from the drilling operation. A robotic manufacturing system includes a machine drill tool and the remnant extraction tool. The machine drill tool engages with a first robotic manipulator. The remnant extraction tool engages with a second robotic manipulator. Methods for extracting remnants during drilling operations at robotic manufacturing systems are also disclosed.

### FIELD

The present disclosure relates generally to extracting temporary fastener remnants during drilling operations at robotic manufacturing systems and, particularly, to automated extraction tools for extracting the remnants. A robotic manufacturing system includes a machine drill tool on the drill entry side of a workpiece for drilling holes in the workpiece. The workpiece contains temporary fasteners, which the robotic manufacturing system synchronizes to its position, and drills through the workpiece and the temporary fastener. The robotic manufacturing systems are equipped with a temporary fastener remnant extraction tool on an exit side of the workpiece. The temporary fastener remnant extraction tool includes a vacuum assembly to collect the remnants from the drilling operations. Robotic manipulators of the robotic manufacturing system control the drilling operation and the collection of remnants.

### BACKGROUND

In aircraft wing spar assembly robotic cells, for example, robots are used to drill through temporary aluminum fasteners as part of the process of assembling stiffeners and rib post attachments to the primary spar structure. Remnants of these temporary fasteners are disposed of by allowing the debris to accumulate on the aircraft component or the production floor. This creates a foreign object debris concern. In certain cases, these remnants become trapped inside the nosepiece of the robotic-controlled drill. These existing processes do not reliably extract the aluminum fastener remnants during the drilling process and can cause a collision with the drill. This can lead to permanent damage when the drill tip exits the workpiece, resulting in a hole size that does not meet the required specifications. The damage to the drill can result in problems with subsequent holes.

Accordingly, those skilled in the art continue with research and development efforts to improve robotic drilling operations.

### SUMMARY

Disclosed are examples of remnant extraction tools, robotic manufacturing systems and methods for extracting remnants during drilling operations at robotic manufacturing systems. The following is a non-exhaustive list of examples, which may or may not be claimed, of the subject matter according to the present disclosure.

In an example, the disclosed remnant extraction tool includes a nosepiece assembly and a vacuum assembly. The nosepiece assembly configured to engage with a robotic manipulator and configured to adjustably align with the drill exit side of a workpiece during a drilling operation through the workpiece at a predetermined location. The drilling operation includes drilling performed by another robotic manipulator from a drilling side of the workpiece. The vacuum assembly in fluidic communication with the nosepiece assembly and configured to engage with the robotic manipulator for operative communication to selectively apply a vacuum to the exit side of the workpiece via the nosepiece assembly and to collect remnants from the drilling operation.

In an example, the disclosed robotic manufacturing system includes a machine drill tool and a remnant extraction tool. The machine drill tool for a first robotic manipulator of the robotic manufacturing system. The machine drill tool including a first nosepiece assembly configured to adjustably align with a temporary fastener on the drill entry side of a workpiece during a drilling operation by the robotic manufacturing system. The first nosepiece assembly configured to engage with the first robotic manipulator for operative communication to selectively drill a hole through the workpiece and the temporary fastener at a predetermined location during the drilling operation. The remnant extraction tool for a second robotic manipulator of the robotic manufacturing system. The remnant extraction tool is equipped on a second nosepiece assembly and a vacuum assembly. The second nosepiece assembly configured to adjustably align with an exit side of the workpiece in conjunction with the drilling operation. The second nosepiece assembly configured to engage with the second robotic manipulator. The vacuum assembly in fluidic communication with the second nosepiece assembly and configured to engage with the second robotic manipulator for operative communication to selectively apply a vacuum to the exit side of the workpiece via the second nosepiece assembly and to collect remnants from the drilling operation.

In an example, the disclosed method for extracting remnants during a drilling operation at a robotic manufacturing system includes: (1) receiving an activation signal from a first robotic manipulator of the robotic manufacturing system at a second robotic manipulator of the robotic manufacturing system, the first robotic manipulator disposed on a drill entry side of the workpiece, the second robotic manipulator disposed on an exit side of the workpiece, the activation signal indicating the drilling operation is initiated; (2) positioning a remnant extraction tool of the second robotic manipulator to a temporary fastener on the workpiece in response to receiving the activation signal; (3) receiving a first displacement signal from the first robotic manipulator, the first displacement signal indicating a machine drill tool of the first robotic manipulator is at a first predetermined position in relation to the drilling side of the workpiece, the first predetermined position indicating a drill bit in the machine drill tool is approaching the drilling side of the workpiece; and (4) activating a vacuum assembly of the remnant extraction tool to apply a vacuum to the exit side of the workpiece to collect remnants from the drilling operation in response to receiving the first displacement signal.

In another example, the disclosed remnant extraction tool includes a nosepiece assembly and a vacuum assembly. The nosepiece assembly configured to engage with a robotic manipulator and configured to adjustably align with an exit side of a workpiece during a drilling operation through the workpiece at a predetermined location. The drilling operation includes drilling performed by another robotic manipulator from a drilling side of the workpiece. The vacuum assembly in fluidic communication with the nosepiece assembly and configured to engage with the robotic manipulator for operative communication to selectively apply a vacuum to the exit side of the workpiece via the nosepiece assembly and to collect remnants from the drilling operation.

In another example, the disclosed robotic manufacturing system includes a machine drill tool and a remnant extraction tool. The machine drill tool for a first robotic manipulator of the robotic manufacturing system. The machine drill tool including a first nosepiece assembly configured to adjustably align with a drilling side of a workpiece during a drilling operation by the robotic manufacturing system. The first nosepiece assembly configured to engage with the first robotic manipulator for operative communication to selectively drill a hole through the workpiece at a predetermined location during the drilling operation. The remnant extraction tool for a second robotic manipulator of the robotic manufacturing system. The remnant extraction tool includes a second nosepiece assembly and a vacuum assembly. The second nosepiece assembly configured to adjustably align with an exit side of the workpiece in conjunction with the drilling operation. The second nosepiece assembly configured to engage with the second robotic manipulator. The vacuum assembly in fluidic communication with the second nosepiece assembly and configured to engage with the second robotic manipulator for operative communication to selectively apply a vacuum to the exit side of the workpiece via the second nosepiece assembly and to collect remnants from the drilling operation.

In another example, the disclosed method for extracting remnants during a drilling operation at a robotic manufacturing system includes: (1) receiving an activation signal from a first robotic manipulator of the robotic manufacturing system at a second robotic manipulator of the robotic manufacturing system, the first robotic manipulator disposed on a drilling side of the workpiece, the second robotic manipulator disposed on an exit side of the workpiece, the activation signal indicating the drilling operation is initiated; (2) positioning a remnant extraction tool of the second robotic manipulator to a predetermined location on the workpiece in response to receiving the activation signal; (3) receiving a first displacement signal from the first robotic manipulator, the first displacement signal indicating a machine drill tool of the first robotic manipulator is at a first predetermined position in relation to the drilling side of the workpiece, the first predetermined position indicating a drill bit in the machine drill tool is approaching the drilling side of the workpiece; and (4) activating a vacuum assembly of the remnant extraction tool to apply a vacuum to the exit side of the workpiece to collect remnants from the drilling operation in response to receiving the first displacement signal.

Other examples of the disclosed remnant extraction tools, robotic manufacturing systems and methods for extracting remnants during drilling operations at robotic manufacturing systems will become apparent from the following detailed description, the accompanying drawings and the appended claims.

### BRIEF DESCRIPTION OF THE DRAWINGS

FIG. 1 is a side view of an example of a remnant extraction tool;

FIG. 2 is a top view of examples of remnants from drilling operations;

FIG. 3 is a side view of an example of a workpiece for a drilling operation;

FIG. 4 is a perspective view of another example of a workpiece that includes a stiffener joint and a spar web;

FIG. 5 is a perspective view of yet another example of a workpiece that includes a spar web and a rib post joint;

FIG. 6 is an exploded view of an example of a nosepiece assembly for the remnant extraction tool of FIG. 1;

FIG. 7 is a functional diagram of another example of a remnant extraction tool with the nosepiece assembly of FIG. 6 shown in cross-section;

FIG. 8 is a functional diagram of an example of a vacuum assembly for the remnant extraction tool of FIG. 1;

FIG. 9 is a functional block diagram of yet another example of a remnant extraction tool;

FIG. 10 is a functional block diagram of still another example of a remnant extraction tool;

FIG. 11 is a functional block diagram of another example of a remnant extraction tool;

FIG. 12 is a functional block diagram of yet another example of a remnant extraction tool;

FIG. 13 is a functional block diagram of an example of a robotic manufacturing system;

FIG. 14 is an exploded view of an example of a first nosepiece assembly in a machine drill tool for the robotic manufacturing system of FIG. 13;

FIG. 15 is a functional block diagram of an example of a machine drill tool for the robotic manufacturing system of FIG. 13;

FIG. 16 is a functional diagram of another example of a machine drill tool with a portion of the first nosepiece assembly of FIG. 14 shown in cross-section;

FIG. 17 is a perspective view of an example of a drill assembly in the first nosepiece assembly of FIG. 14;

FIG. 18 is a functional block diagram of another example of a robotic manufacturing system;

FIG. 19 is a flow diagram of an example of a method for extracting remnants during a drilling operation at a robotic manufacturing system;

FIG. 20, in combination with FIG. 19, is a flow diagram of another example of a method for extracting remnants during a drilling operation at a robotic manufacturing system;

FIG. 21 is a flow diagram of an example of the positioning of the machine drill tool in the method of FIG. 20;

FIG. 22, in combination with FIGS. 19 and 20, is a flow diagram of yet another example of a method for extracting remnants during a drilling operation at a robotic manufacturing system;

FIG. 23, in combination with FIG. 19, is a flow diagram of still another example of a method for extracting remnants during a drilling operation at a robotic manufacturing system;

FIG. 24 is a flow diagram of an example of the positioning of the remnant extraction tool in the method of FIG. 19;

FIG. 25, in combination with FIG. 19, is a flow diagram of still yet another example of a method for extracting remnants during a drilling operation at a robotic manufacturing system;

FIG. 26, in combination with FIG. 19, is a flow diagram of another example of a method for extracting remnants during a drilling operation at a robotic manufacturing system;

FIG. 27 is a block diagram of aircraft production and service methodology that implements using one or more of the examples of remnant extraction tools, robotic manufacturing systems and methods for extracting remnants during drilling operations at robotic manufacturing systems disclosed herein to fabricate components of the aircraft; and

FIG. 28 is a schematic illustration of an aircraft that incorporates components fabricated using one or more of the examples of remnant extraction tools, robotic manufacturing systems and methods for extracting remnants during drilling operations at robotic manufacturing systems disclosed herein.

### DETAILED DESCRIPTION

The various examples of remnant extraction tools 100, robotic manufacturing systems 1300 and methods 1900, 2000, 2200, 2300, 2500, 2600 for extracting remnants 200 during drilling operations 110 at robotic manufacturing systems 1300 provide an automated tack remnant extraction system to extract, for example, aluminum fastener debris by using an integrated vacuum before the drilling process is completes. The automated tack remnant extraction system includes a slotted ball tip, a nosepiece extension with vacuum ports, an inline venturi vacuum system and a fixed pressure foot mount. The vacuum timing is controlled by a numerical control program that aligns to a specific position of the drill tip during the drilling process. When activated, the vacuum extracts the aluminum fastener remnants through the base of the nosepiece extension and collects them in, for example, a disposable container. Additionally, the base of the nosepiece extension is equipped with a slot to insert a borescope in case, for example, a camera is needed for inspection inside the nosepiece extension and the slotted ball tip during the drilling process.

The automated tack remnant extraction system prevents the debris (i.e., drilling remnants) from collecting on the production area, eliminating foreign object damage, and reducing the risk of damage to the drill. The system includes an automation nosepiece to efficiently extract the remnants using vacuum ports situated near the tip. The configuration of the ports are optimized to expedite the tack remnant extraction using an in-line venturi vacuum at its base before the drilling process completes, eliminating the risk of collision with the drill bit. The system no longer requires rotation to clear the aircraft component. Its geometry is optimized to ensure clearance at all space-constrained locations.

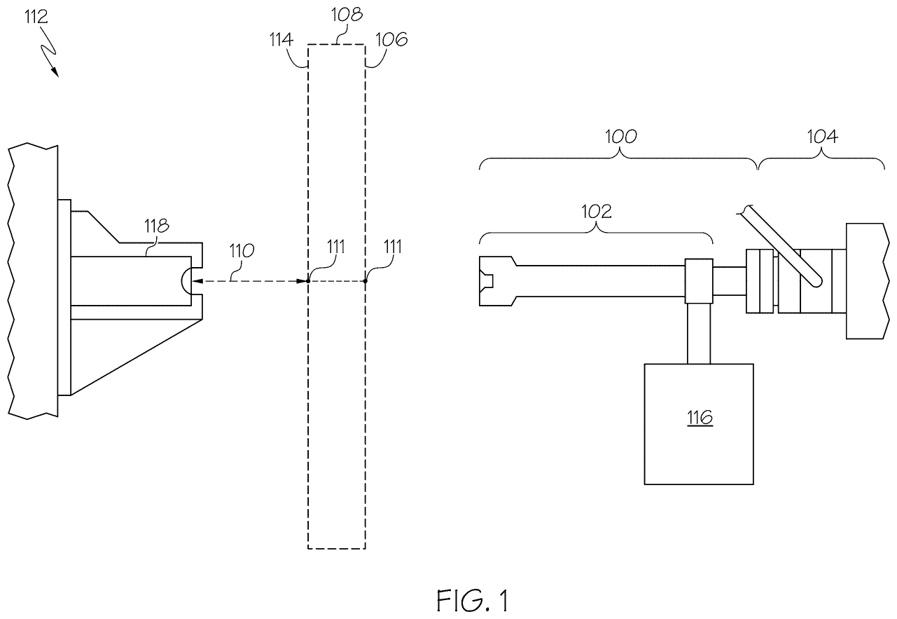

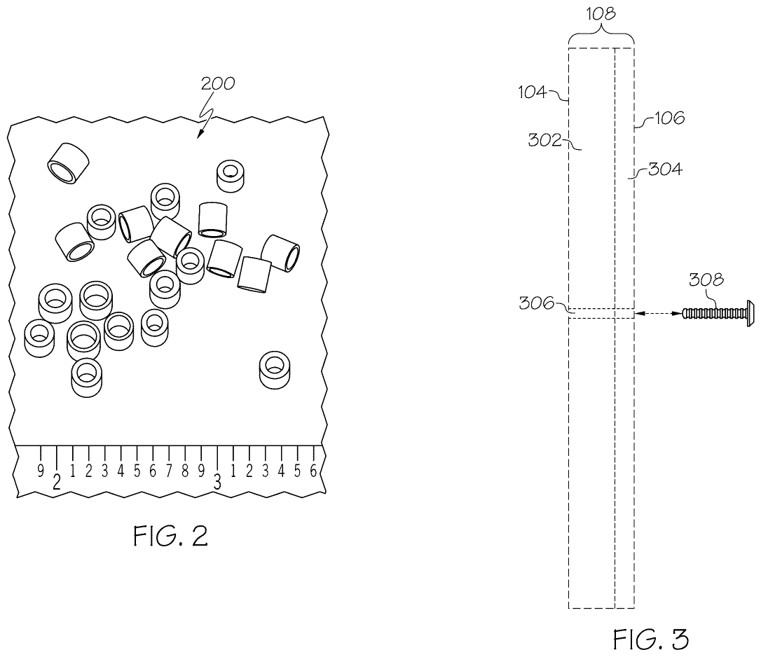

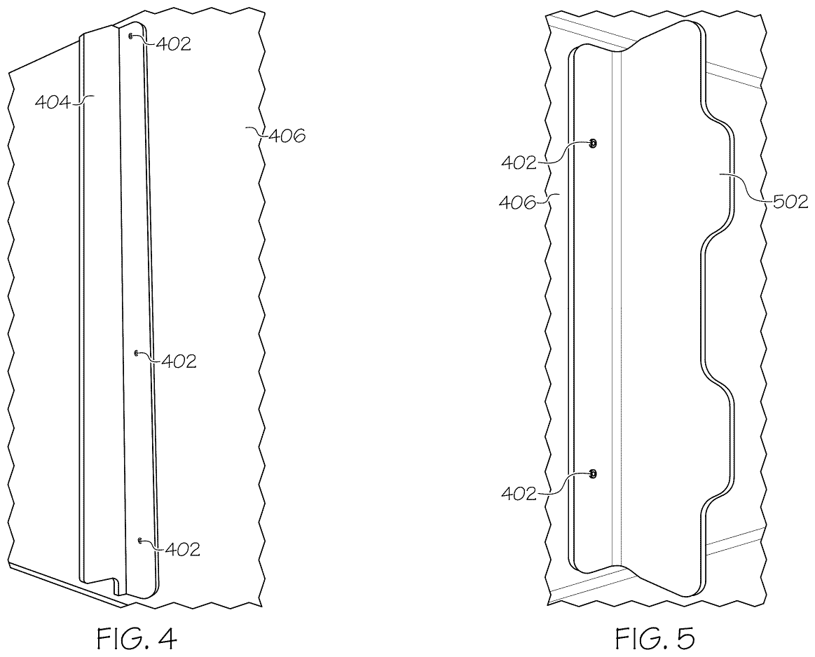

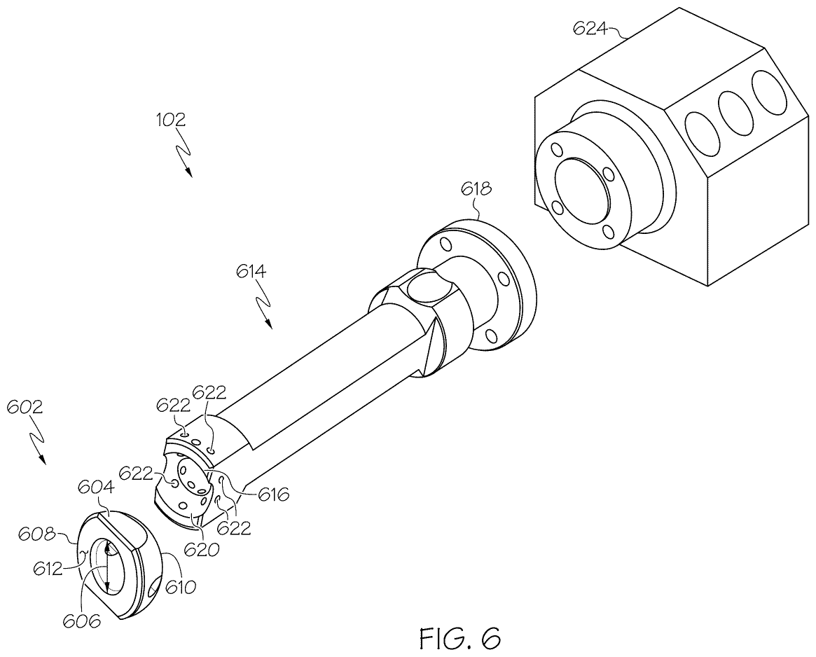

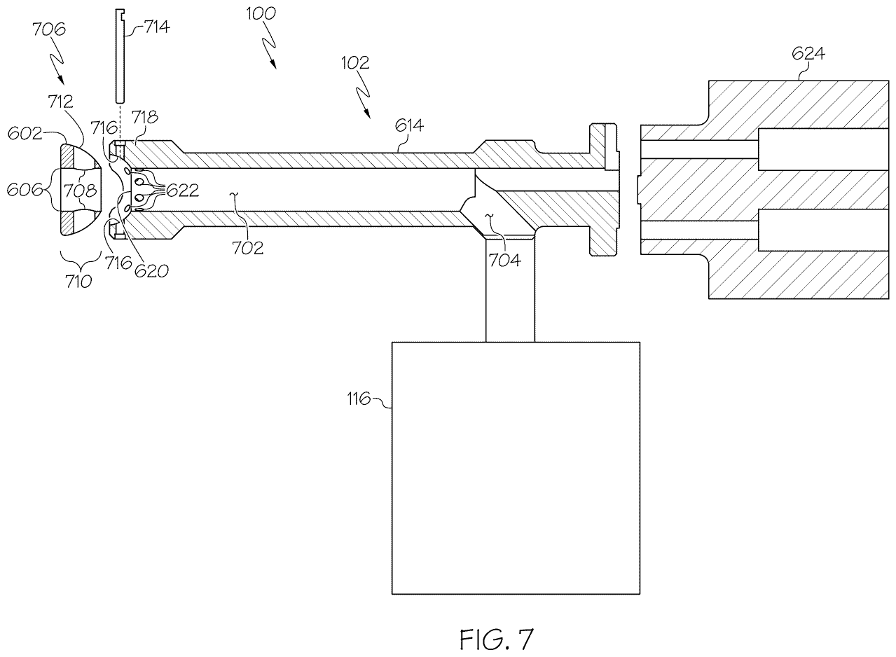

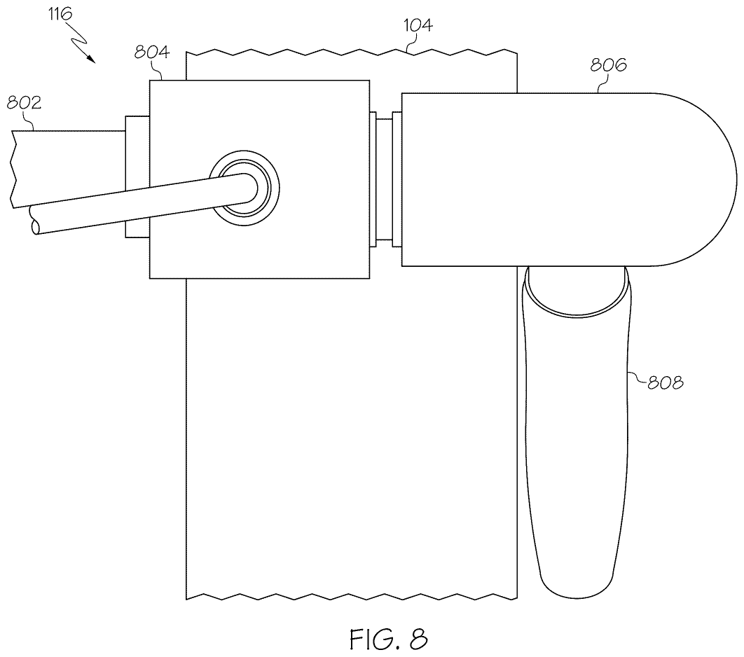

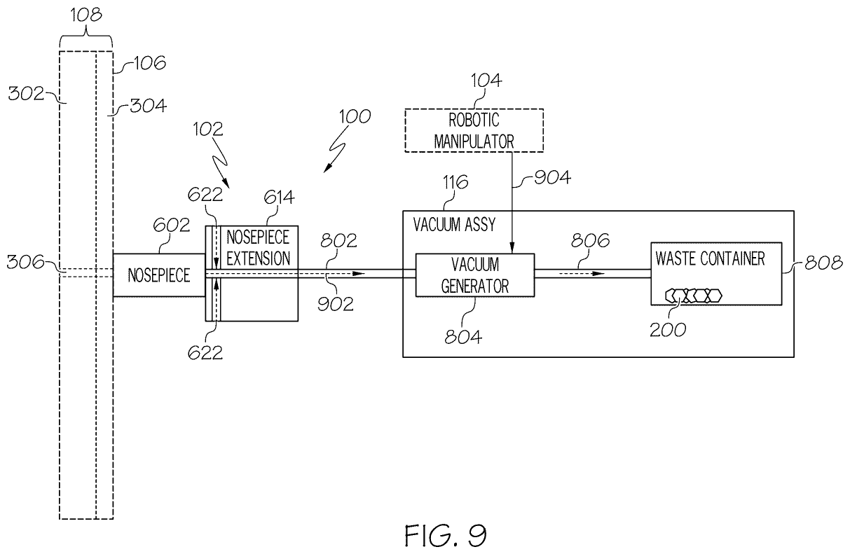

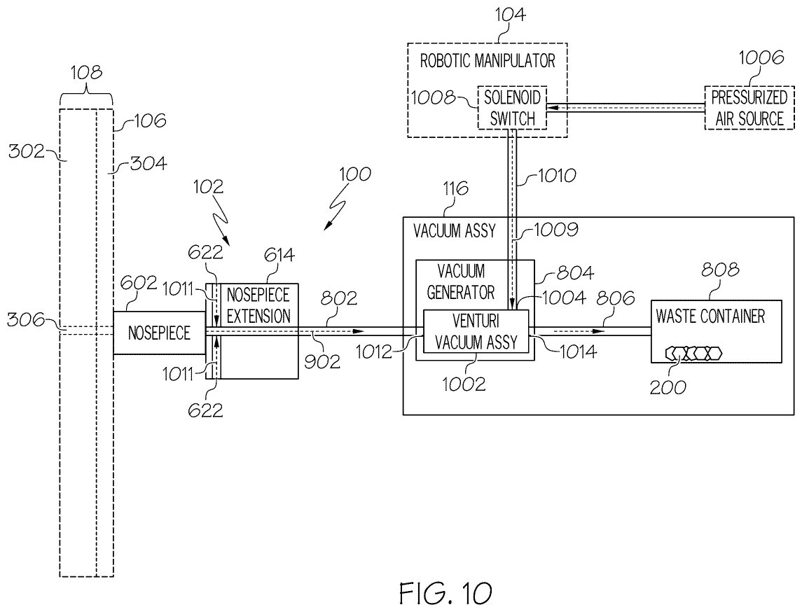

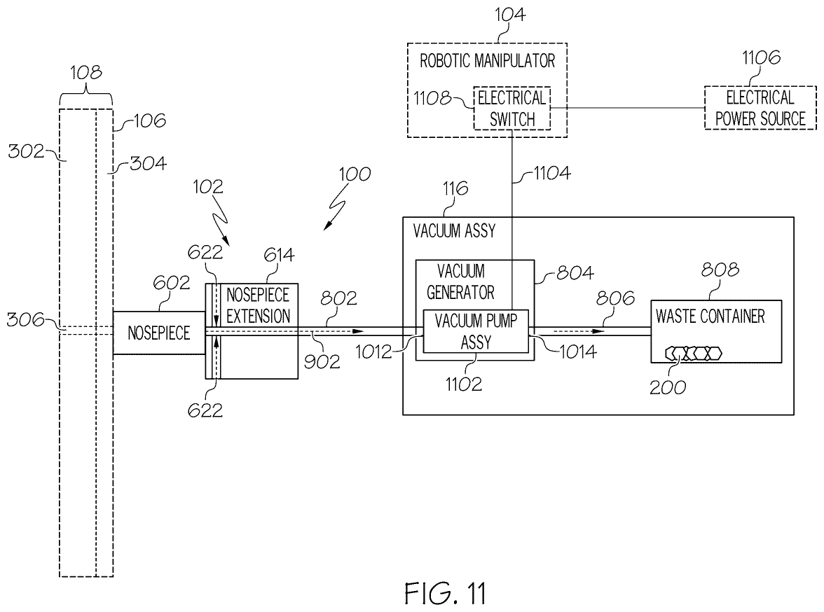

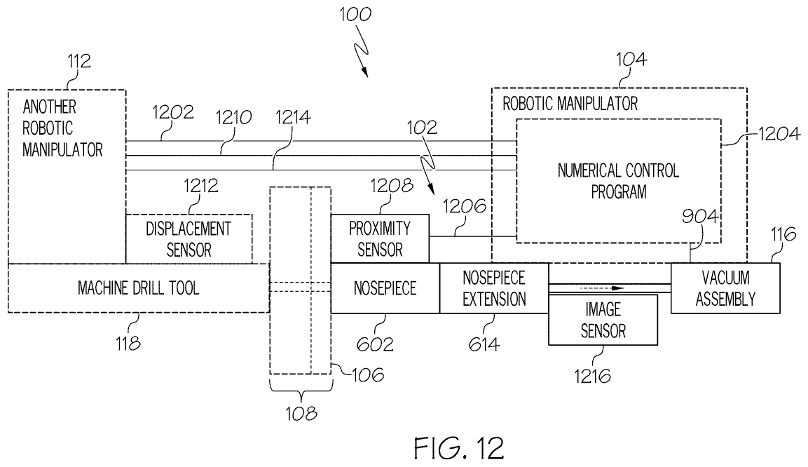

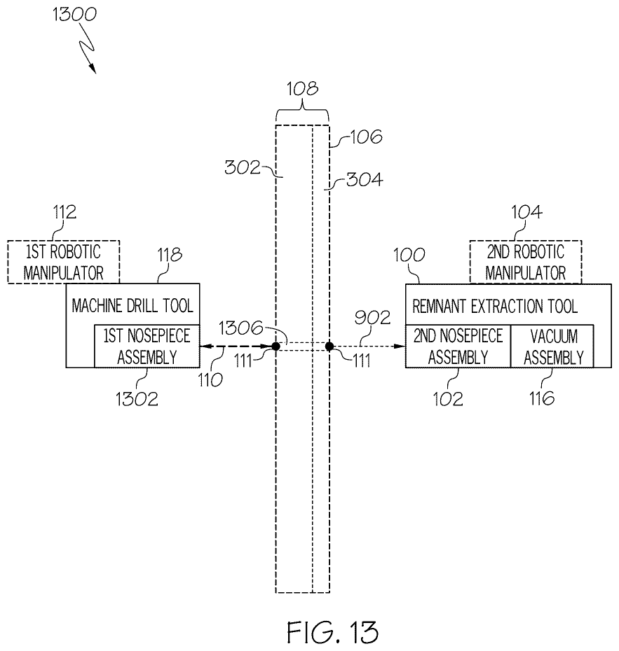

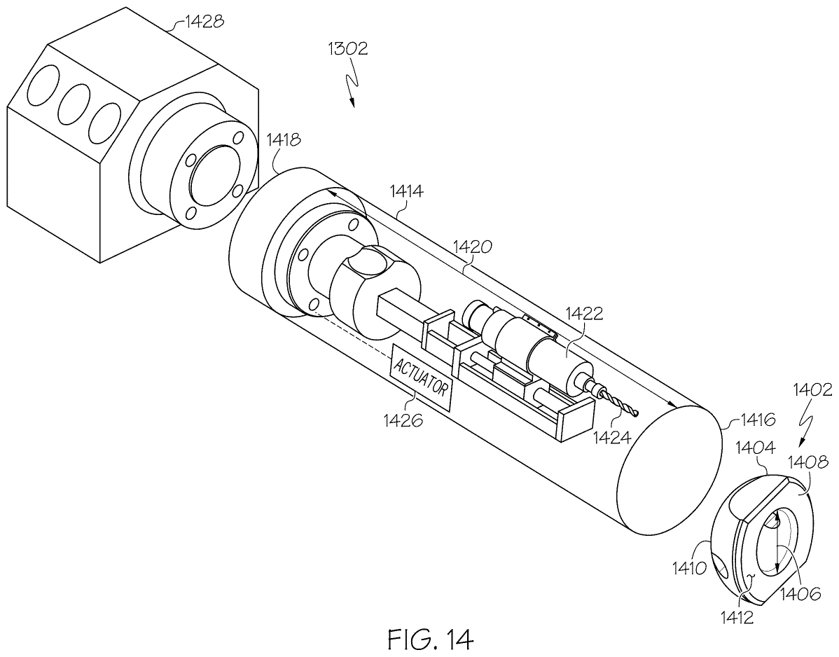

Referring generally to FIGS. 1-14, by way of examples, the present disclosure is directed to a remnant extraction tool 100. FIG. 1 is a side view of an example of the remnant extraction tool 100. FIG. 2 is a top view of examples of remnants 200 from drilling operations 110. FIG. 3 is a side view of an example of a workpiece 108 for a drilling operation 110. FIG. 4 is a perspective view of another example of a workpiece 108 that includes a stiffener joint 404 and a spar web 406. FIG. 5 is a perspective view of yet another example of a workpiece 108 that includes a spar web 406 and a rib post joint 502. FIG. 6 is an exploded view of an example of a nosepiece assembly 102 for the remnant extraction tool 100 of FIG. 1. FIG. 7 is a functional diagram of another example of the remnant extraction tool 100 with the nosepiece assembly 102 of FIG. 6 shown in cross-section. FIG. 8 is a functional diagram of an example of a vacuum assembly 116 for the remnant extraction tool 100 of FIG. 1. FIG. 9 is a functional block diagram of yet another example of the remnant extraction tool 100. FIG. 10 is a functional block diagram of still another example of the remnant extraction tool 100. FIG. 11 is a functional block diagram of another example of the remnant extraction tool 100. FIG. 12 is a functional block diagram of yet another example of the remnant extraction tool 100. FIG. 13 is a functional block diagram of an example of a robotic manufacturing system 1300. FIG. 14 is an exploded view of an example of a first nosepiece assembly 1302 in a machine drill tool 118 for the robotic manufacturing system 1300 of FIG. 13.

With reference again to FIGS. 1-14, in one or more example, a remnant extraction tool 100 includes a nosepiece assembly 102 and a vacuum assembly 116. The nosepiece assembly 102 configured to engage with a robotic manipulator 104 and configured to adjustably align with an exit side 106 of a workpiece 108 during a drilling operation 110 through the workpiece 108 at a predetermined location 111. The drilling operation 110 includes drilling performed by another robotic manipulator 112 from a drilling side 114 of the workpiece 108. The vacuum assembly 116 in fluidic communication with the nosepiece assembly 102 and configured to engage with the robotic manipulator 104 for operative communication to selectively apply a vacuum 902 to the exit side 106 of the workpiece 108 via the nosepiece assembly 102 and to collect remnants 200 from the drilling operation 110.

In another example of the remnant extraction tool 100, the robotic manipulator 104 includes a robotic arm, an articulated robotic arm, a 4-axis robotic arm, a 6-axis robotic arm, a collaborative robot or any other suitable type of robotic manipulator in any suitable combination.

In yet another example of the remnant extraction tool 100, the workpiece 108 includes a first material component 302 and a second material component 304. In a further example, the workpiece 108 includes a previously drilled hole 306 through the first material component 302 and the second material component 304, and a fastener 308 installed in the previously drilled hole 306. In an even further example, the fastener 308 includes a metallic material, an aluminum material, an aluminum alloy material or any other suitable metallic material. In another even further example, the fastener 308 includes a tack fastener 402. In yet another even further example, the drilling operation 110 includes drilling out the fastener 308. In another further example, the first material component 302 includes a metallic material, an aluminum material, an aluminum alloy material, a polymeric composite material, a thermoplastic composite material, a thermoset composite material or any other suitable type of material in any suitable combination. In yet another further example, the second material component 304 includes a metallic material, an aluminum material, an aluminum alloy material, a polymeric composite material, a thermoplastic composite material, a thermoset composite material or any other suitable type of material in any suitable combination. In still another further example, the first material component 302 includes a stiffener joint 404, and the second material component 304 includes a spar web 406 for an aircraft wing. In still yet another further example, the first material component 302 includes a spar web 406 for an aircraft wing and the second material component 304 includes a rib post joint 502.

In still another example of the remnant extraction tool 100, the another robotic manipulator 112 includes a robotic arm, an articulated robotic arm, a 4-axis robotic arm, a 6-axis robotic arm, a collaborative robot or any other suitable type of robotic manipulator in any suitable combination.

In still yet another example of the remnant extraction tool 100, the nosepiece assembly 102 includes a nosepiece 602, a nosepiece extension 614 and a foot mount member 624. The nosepiece 602 including a body 604 with an aperture 606 extending from a first distal end 608 to a first proximal end 610 and an exterior surface 612 at the first distal end 608. The nosepiece 602 configured to adjustably align the exterior surface 612 with the exit side 106 of the workpiece 108 during the drilling operation 110. The nosepiece extension 614 with a second distal end 616 and a second proximal end 618 and including a concave cavity 620 at the second distal end 616 that receives the nosepiece 602. The nosepiece extension 614 also includes at least one ambient air input vent 622, a channel 702 and a vacuum port 704. The at least one ambient air input vent 622 is open to receive ambient air. The channel 702 is in fluidic communication with the aperture 606 and the at least one ambient air input vent 622. The vacuum port 704 is in fluidic communication with the channel 702 and the vacuum assembly 116. The foot mount member 624 is installed on the second proximal end 618 of the nosepiece extension 614 and configured to engage with the robotic manipulator 104. In a further example, the nosepiece 602 includes a slotted ball tip 706 with first slots 708 through a central portion 710 of the body 604 transverse to the aperture 606, a convex shape 712 to the body 604, and a pin 714 for insertion through the first slots 708 and second slots 716 in walls 718 of the concave cavity 620 at the second distal end 616 of the nosepiece extension 614 for connecting the nosepiece 602 to the nosepiece extension 614.

In another example of the remnant extraction tool 100, the vacuum assembly 116 includes a first vacuum line 802, a vacuum generator 804, a second vacuum line 806 and a waste container 808. The first vacuum line 802 connected to the nosepiece assembly 102 and in fluidic communication with the exit side 106 of the workpiece 108 and the at least one ambient air input vent 622 via the nosepiece assembly 102 during the drilling operation 110. The vacuum generator 804 in fluidic communication with the nosepiece assembly 102 via the first vacuum line 802 and configured to engage with the robotic manipulator 104 for operative communication. The second vacuum line 806 connected to the vacuum generator 804. The waste container 808 connected to the second vacuum line 806 and configured for installation on the robotic manipulator 104. In a further example, the vacuum generator 804 is configured to selectively apply the vacuum 902 to the exit side 106 of the workpiece 108 via the nosepiece assembly 102 and the first vacuum line 802 during the drilling operation 110 in response to vacuum control inputs 904 received from the robotic manipulator 104. In an even further example, the waste container 808 is configured to collect remnants 200 from the drilling operation 110 in conjunction with the vacuum 902 applied to the exit side 106 of the workpiece 108 by the vacuum generator 804.

In another further example, the vacuum generator 804 includes a venturi vacuum assembly 1002 with a pressurized pneumatic input port 1004 in operative communication with a pressurized air source 1006 via a solenoid switch 1008 operated by the robotic manipulator 104 and configured to provide pressurized air 1009 to the venturi vacuum assembly 1002 via a pressurized air line 1010. The pressurized air 1009 creates a venturi effect in conjunction with ambient air 1011 flowing in the at least one ambient air input vent 622 to generate the vacuum 902 during the drilling operation 110. The venturi vacuum assembly 1002 also including vacuum suction port 1012 in fluidic communication with the exit side 106 of the workpiece 108 via the nosepiece assembly 102 and the first vacuum line 802 and configured to provide the vacuum 902 to the exit side 106 during the drilling operation 110. The venturi vacuum assembly 1002 also includes a vacuum exhaust port 1014 in fluidic communication with the waste container 808 via the second vacuum line 806 and configured to collect remnants 200 from the drilling operation 110.

In yet another further example, the vacuum generator 804 includes a vacuum pump assembly 1102 with an electrical power connection 1104 in operative communication with an electrical power source 1106 via an electrical switch 1108 operated by the robotic manipulator 104 to activate the vacuum pump assembly 1102 and configured to generate the vacuum 902 in response to activation of the vacuum pump assembly 1102 in conjunction with ambient air 1011 flowing in the at least one ambient air input vent 622 during the drilling operation 110. The vacuum pump assembly 1102 also includes a vacuum suction port 1012 in fluidic communication with the exit side 106 of the workpiece 108 via the nosepiece assembly 102 and the first vacuum line 802 and configured to provide the vacuum 902 to the exit side 106 during the drilling operation 110. The vacuum pump assembly 1102 also includes a vacuum exhaust port 1014 in fluidic communication with the waste container 808 via the second vacuum line 806 and configured to collect remnants 200 from the drilling operation 110.

In yet another example of the remnant extraction tool 100, the robotic manipulator 104 is configured to position the remnant extraction tool 100 to the predetermined location 111 on the workpiece 108 in response to an activation signal 1202 from the another robotic manipulator 112 indicating the drilling operation 110 is initiated. In a further example, positioning of the remnant extraction tool 100 to the predetermined location 111 is controlled by a numerical control program 1204 at the robotic manipulator 104. In an even further example, the positioning of the remnant extraction tool 100 to the predetermined location 111 is further controlled by the robotic manipulator 104 in response to a proximity signal 1206 from a proximity sensor 1208 installed on the nosepiece assembly 102 to detect the exit side 106 of the workpiece 108. In another further example, positioning of the remnant extraction tool 100 to the predetermined location 111 by the robotic manipulator 104 includes aligning the nosepiece assembly 102 with the exit side 106 of the workpiece 108 and applying a force on the exit side 106 of the workpiece 108 via the remnant extraction tool 100 to surround the predetermined location 111 with the nosepiece assembly 102 to prepare for the drilling operation 110 and collection of the remnants 200 from the drilling operation 110.

In yet another further example, the robotic manipulator 104 is configured to apply the vacuum 902 to the exit side 106 of the workpiece 108 in response to a first displacement signal 1210 from a displacement sensor 1212 of a machine drill tool 118 of the another robotic manipulator 112 indicating a first predetermined position of the machine drill tool 118 after initiation of the drilling operation 110. The first predetermined position associated with a first time prior to a drill bit 1424 on the machine drill tool 118 engaging with the drilling side 114 of the workpiece 108 at which the vacuum assembly 116 is to be activated. In an even further example, the robotic manipulator 104 is configured to stop applying the vacuum 902 to the exit side 106 of the workpiece 108 in response to a second displacement signal 1214 from the displacement sensor 1212 indicating a second predetermined position of the machine drill tool 118 after completion of the drilling operation 110. The second predetermined position is associated with a second time after which the vacuum assembly 116 is to be deactivated.

In another even further example, the nosepiece assembly 102 includes an image sensor 1216 oriented to selectively capture images 1218 of the predetermined location 111 at the exit side 106 of the workpiece 108 during the drilling operation 110. In an even yet further example, the image sensor 1216 includes a digital video camera, a digital camera, a charge-coupled device, an active-pixel device, an optical scanner, a laser scanner or any other suitable image sensor in any suitable combination. In another even yet further example, robotic manipulator 104 is configured to receive the images 1218 from the image sensor 1216, to analyze the images 1218 and to stop applying the vacuum 902 to the exit side 106 of the workpiece 108 in response to detecting the drilling operation 110 is complete based on the images 1218 from the image sensor 1216. In yet another even yet further example, robotic manipulator 104 is configured to receive the images 1218 from the image sensor 1216, to analyze the images 1218 and to inspect results of the drilling operation 110 based on the images 1218 from the image sensor 1216.

Referring generally to FIGS. 1-18, by way of examples, the present disclosure is directed to a robotic manufacturing system 1300. FIG. 1 is a side view of an example of a remnant extraction tool 100. FIG. 2 is a top view of examples of remnants 200 from drilling operations 110. FIG. 3 is a side view of an example of a workpiece 108 for a drilling operation 110. FIG. 4 is a perspective view of another example of a workpiece 108 that includes a stiffener joint 404 and a spar web 406. FIG. 5 is a perspective view of yet another example of a workpiece 108 that includes a spar web 406 and a rib post joint 502. FIG. 6 is an exploded view of an example of a nosepiece assembly 102 for the remnant extraction tool 100 of FIG. 1. FIG. 7 is a functional diagram of another example of a remnant extraction tool 100 with the nosepiece assembly 102 of FIG. 6 shown in cross-section. FIG. 8 is a functional diagram of an example of a vacuum assembly 116 for the remnant extraction tool 100 of FIG. 1. FIG. 9 is a functional block diagram of yet another example of a remnant extraction tool 100. FIG. 10 is a functional block diagram of still another example of a remnant extraction tool 100. FIG. 11 is a functional block diagram of another example of the remnant extraction tool 100. FIG. 12 is a functional block diagram of yet another example of a remnant extraction tool 100.

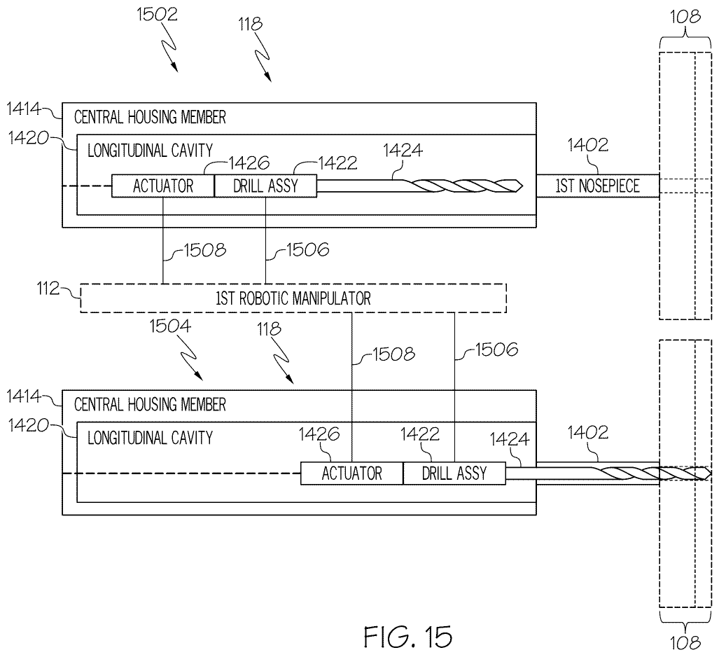

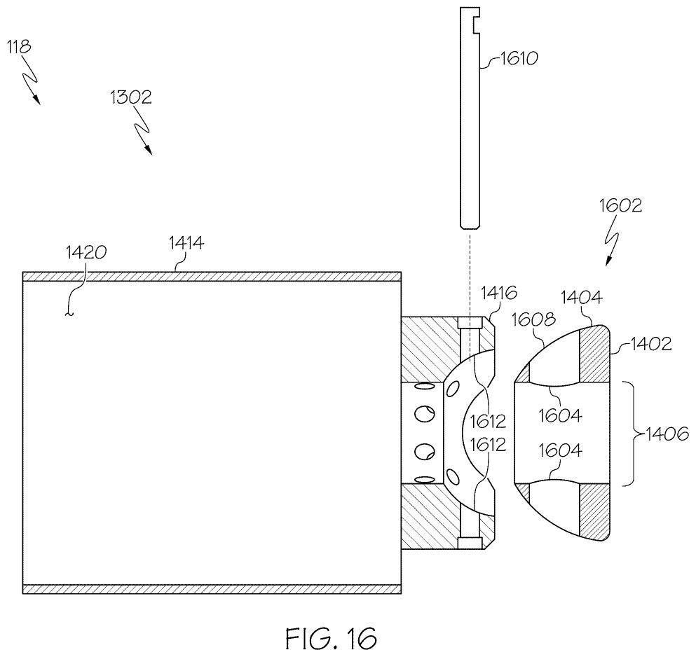

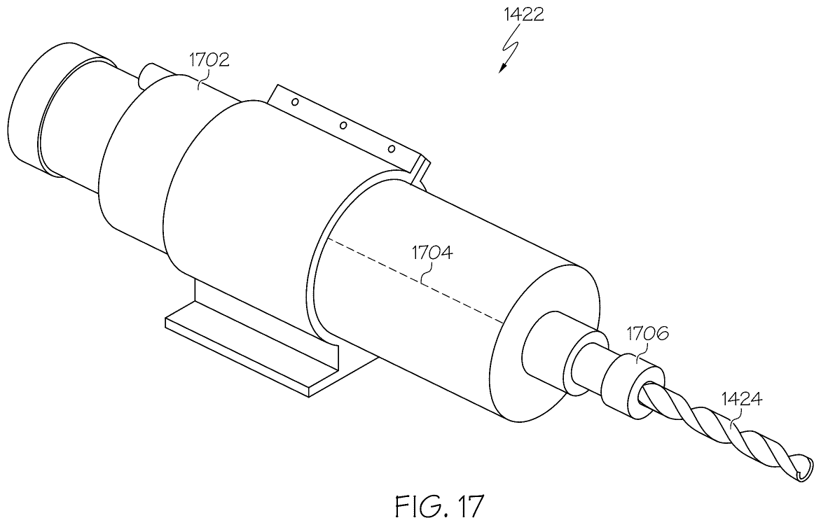

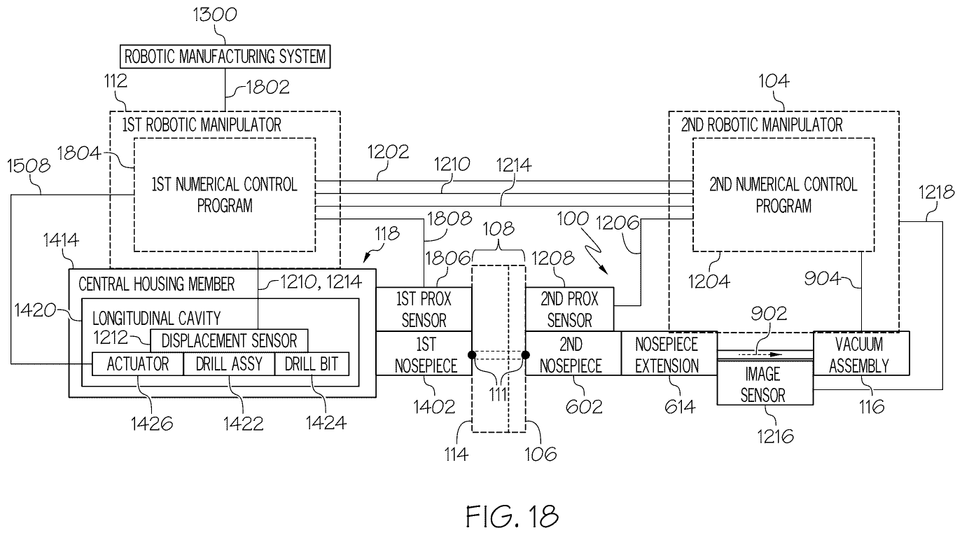

FIG. 13 is a functional block diagram of an example of the robotic manufacturing system 1300. FIG. 14 is an exploded view of an example of a first nosepiece assembly 1302 in a machine drill tool 118 for the robotic manufacturing system 1300 of FIG. 13. FIG. 15 is a functional block diagram of an example of a machine drill tool 118 for the robotic manufacturing system 1300 of FIG. 13. FIG. 16 is a functional diagram of another example of the machine drill tool 118 with a portion of the first nosepiece assembly 1302 of FIG. 14 shown in cross-section. FIG. 17 is a perspective view of an example of a drill assembly 1422 in the first nosepiece assembly 1302 of FIG. 14. FIG. 18 is a functional block diagram of another example of the robotic manufacturing system 1300.

With reference again to FIGS. 1-18, in one or more example, a robotic manufacturing system 1300 includes a machine drill tool 118 and a remnant extraction tool 100. The machine drill tool 118 for a first robotic manipulator 112 of the robotic manufacturing system 1300. The machine drill tool 118 including a first nosepiece assembly 1302 configured to adjustably align with a drilling side 114 of a workpiece 108 during a drilling operation 110 by the robotic manufacturing system 1300. The first nosepiece assembly 1302 configured to engage with the first robotic manipulator 112 for operative communication to selectively drill a hole 306 through the workpiece 108 at a predetermined location 111 during the drilling operation 110. The remnant extraction tool 100 for a second robotic manipulator 104 of the robotic manufacturing system 1300. The remnant extraction tool 100 includes a second nosepiece assembly 102 and a vacuum assembly 116. The second nosepiece assembly 102 configured to adjustably align with an exit side 106 of the workpiece 108 in conjunction with the drilling operation 110. The second nosepiece assembly 102 configured to engage with the second robotic manipulator 104. The vacuum assembly 116 in fluidic communication with the second nosepiece assembly 102 and configured to engage with the second robotic manipulator 104 for operative communication to selectively apply a vacuum 902 to the exit side 106 of the workpiece 108 via the second nosepiece assembly 102 and to collect remnants 200 from the drilling operation 110.

In another example of the robotic manufacturing system 1300, the first robotic manipulator 112 includes a robotic arm, an articulated robotic arm, a 4-axis robotic arm, a 6-axis robotic arm, a collaborative robot or any other suitable type of robotic manipulator in any suitable combination.

In yet another example of the robotic manufacturing system 1300, the workpiece 108 includes a first material component 302 and a second material component 304. In a further example, the workpiece 108 includes a previously drilled hole 306 through the first material component 302 and the second material component 304, and a fastener 308 installed in the previously drilled hole 306. In an even further example, the fastener 308 includes a metallic material, an aluminum material, an aluminum alloy material or any other suitable material in any suitable combination. In another even further example, the fastener 308 includes a tack fastener 402. In yet another even further example, the drilling operation 110 includes drilling out the fastener 308. In another further example, the first material component 302 includes a metallic material, an aluminum material, an aluminum alloy material, a polymeric composite material, a thermoplastic composite material, a thermoset composite material or any other suitable type of material in any suitable combination. In yet another further example, the second material component 304 includes a metallic material, an aluminum material, an aluminum alloy material, a polymeric composite material, a thermoplastic composite material, a thermoset composite material or any other suitable type of material in any suitable combination.

In still another further example, the first material component 302 includes a stiffener joint 404, and the second material component 304 includes a spar web 406 for an aircraft wing. In still yet another further example, the first material component 302 includes a spar web 406 for an aircraft wing and the second material component 304 includes a rib post joint 502. In still another example of the robotic manufacturing system 1300, the second robotic manipulator 104 includes a robotic arm, an articulated robotic arm, a 4-axis robotic arm, a 6-axis robotic arm, a collaborative robot or any other suitable type of robotic manipulator in any suitable combination.

In still yet another example of the robotic manufacturing system 1300, the first nosepiece assembly 1302 includes a first nosepiece 1402, a central housing member 1414, a drill assembly 1422, an actuator 1426 and a foot mount member 1428. The first nosepiece 1402 including a body 1404 with an aperture 1406 extending from a first distal end 1408 to a first proximal end 1410 and an exterior surface 1412 at the first distal end 1408. The first nosepiece 1402 configured to adjustably align the exterior surface 1412 with the drilling side 114 of the workpiece 108 during the drilling operation 110. The central housing member 1414 with a second distal end 1416 and a second proximal end 1418 that receives the first nosepiece 1402. The central housing member 1414 includes a longitudinal cavity 1420 between the second distal end 1416 and second proximal end 1418. The longitudinal cavity 1420 in fluidic communication with the aperture 1406 at the second distal end 1416. The drill assembly 1422 is disposed within the central housing member 1414 and configured to receive a drill bit 1424. The drill assembly 1422 configured to selectively move within the longitudinal cavity 1420 between an inactive position 1502 and a drilling position 1504 during the drilling operation 110. The drill assembly 1422 configured to engage with the first robotic manipulator 112 for operative communication to selectively control rotation of the drill bit 1424 during the drilling operation 110. The drill bit 1424 engaging with the drilling side 114 of the workpiece 108 when the drill assembly 1422 is at the drilling position 1504. The drill assembly 1422 and the drill bit 1424 configured to selectively perform drilling associated with the drilling operation 110 in response to drilling control inputs 1506 received by the drill assembly 1422 from the first robotic manipulator 112 during the drilling operation 110. The actuator 1426 mechanically linked to the central housing member 1414 and the drill assembly 1422. The actuator 1426 configured to engage with the first robotic manipulator 112 for operative communication to selectively control linear movement of the drill assembly 1422 within the longitudinal cavity 1420 between the inactive position 1502 and the drilling position 1504 in response to position control inputs 1508 received from the first robotic manipulator 112 during the drilling operation 110. The foot mount member 1428 installed on the second proximal end 1418 of the central housing member 1414 and configured to engage with the first robotic manipulator 112.

In a further example, the first nosepiece 1402 includes a slotted ball tip 1602 with first slots 1604 through a central portion 1606 of the body 1404 transverse to the aperture 1406, a convex shape 1608 to the body 1404, and a pin 1610 for insertion through the first slots 1604 and second slots 1612 in the second distal end 1416 of the central housing member 1414 for connecting the first nosepiece 1402 to the central housing member 1414. In another further example, the drill assembly 1422 including a rotational drive 1702, a drive shaft 1704, and a bit clamp 1706. The rotational drive 1702 configured to selectively provide a rotational force for rotation of the drill bit 1424 during the drilling operation 110. The drive shaft 1704 coupled to the rotational drive 1702 and configured to selectively rotate in response to the rotational force from the rotational drive 1702. The bit clamp 1706 attached to the drive shaft 1704 and configured to selectively rotate in response to the rotational force. The bit clamp 1706 configured to selectively receive and secure the drill bit 1424. In yet another further example, the actuator 1426 includes a linear actuator, a stepper motor, a gearbox, a corkscrew drive, a belt drive, a hydraulic cylinder, a pneumatic cylinder or any other suitable actuator in any suitable combination.

In another example of the robotic manufacturing system 1300, the second nosepiece assembly 102 including a second nosepiece 602, a nosepiece extension 614 and a foot mount member 624. The second nosepiece 602 including a body 604 with an aperture 606 extending from a first distal end 608 to a first proximal end 610 and an exterior surface 612 at the first distal end 608. The second nosepiece 602 configured to adjustably align the exterior surface 612 with the exit side 106 of the workpiece 108 during the drilling operation 110. The nosepiece extension 614 with a second distal end 616 and a second proximal end 618 and including a concave cavity 620 at the second distal end 616 that receives the second nosepiece 602. The nosepiece extension 614 also includes at least one ambient air input vent 622, a channel 702 and a vacuum port 704. The at least one ambient air input vent 622 is open to receive ambient air. The channel 702 is in fluidic communication with the aperture 606 and the at least one ambient air input vent 622. The vacuum port 704 is in fluidic communication with the channel 702 and the vacuum assembly 116. The foot mount member 624 installed on the second proximal end 618 of the nosepiece extension 614 and configured to engage with the second robotic manipulator 104. In a further example, the second nosepiece 602 includes a slotted ball tip 706 with first slots 708 through a central portion 710 of the body 604 transverse to the aperture 606, a convex shape 712 to the body 604, and a pin 714 for insertion through the first slots 708 and second slots 716 in walls 718 of the concave cavity 620 at the second distal end 616 of the nosepiece extension 614 for connecting the second nosepiece 602 to the nosepiece extension 614.

In yet another example of the robotic manufacturing system 1300, the vacuum assembly 116 including a first vacuum line 802, a vacuum generator 804, a second vacuum line 806 and a waste container 808. The first vacuum line 802 connected to the second nosepiece assembly 102 and in fluidic communication with the exit side 106 of the workpiece 108 and the at least one ambient air input vent 622 via the second nosepiece assembly 102 during the drilling operation 110. The vacuum generator 804 is in fluidic communication with the second nosepiece assembly 102 via the first vacuum line 802 and configured to engage with the second robotic manipulator 104 for operative communication to selectively apply the vacuum 902 to the exit side 106 of the workpiece 108. The second vacuum line 806 connected to the vacuum generator 804. The waste container 808 connected to the second vacuum line 806 and configured for installation on the second robotic manipulator 104. In a further example, the vacuum generator 804 is configured to selectively apply the vacuum 902 to the exit side 106 of the workpiece 108 via the second nosepiece assembly 102 and the first vacuum line 802 during the drilling operation 110 in response to vacuum control inputs 904 received from the second robotic manipulator 104. In an even further example, the waste container 808 is configured to collect remnants 200 from the drilling operation 110 in conjunction with the vacuum 902 applied to the exit side 106 of the workpiece 108 by vacuum generator 804.

In yet another example, the vacuum generator 804 including a venturi vacuum assembly 1002 with a pressurized pneumatic input port 1004 in operative communication with a pressurized air source 1006 via a solenoid switch 1008 operated by the second robotic manipulator 104 and configured to provide pressurized air 1009 to the venturi vacuum assembly 1002 via a pressurized air line 1010. The pressurized air 1009 creates a venturi effect in conjunction with ambient air 1011 flowing in the at least one ambient air input vent 622 to generate the vacuum 902 during the drilling operation 110. The venturi vacuum assembly 1002 also includes a vacuum suction port 1012 in fluidic communication with the exit side 106 of the workpiece 108 via the second nosepiece assembly 102 and the first vacuum line 802 and configured to provide the vacuum 902 to the exit side 106 during the drilling operation 110. The venturi vacuum assembly 1002 also includes a vacuum exhaust port 1014 in fluidic communication with the waste container 808 via the second vacuum line 806 and configured to collect remnants 200 from the drilling operation 110.

In still another example, the vacuum generator 804 including a vacuum pump assembly 1102 with an electrical power connection 1104 in operative communication with an electrical power source 1106 via an electrical switch 1108 operated by the second robotic manipulator 104 to activate the vacuum pump assembly 1102 and configured to generate the vacuum 902 in response to activation of the vacuum pump assembly 1102 in conjunction with ambient air 1011 flowing in the at least one ambient air input vent 622 during the drilling operation 110. The vacuum pump assembly 1102 also includes a vacuum suction port 1012 in fluidic communication with the exit side 106 of the workpiece 108 via the second nosepiece assembly 102 and the first vacuum line 802 and configured to provide the vacuum 902 to the exit side 106 during the drilling operation 110. The vacuum pump assembly 1102 also includes a vacuum exhaust port 1014 in fluidic communication with the waste container 808 via the second vacuum line 806 and configured to collect remnants 200 from the drilling operation 110.

In still another example of the robotic manufacturing system 1300, the first robotic manipulator 112 is configured to initiate the drilling operation 110 and position the machine drill tool 118 to the predetermined location 111 on the workpiece 108 in response to receiving a start signal 1802 from the robotic manufacturing system 1300. In a further example, first robotic manipulator 112 is configured to send an activation signal 1202 to the second robotic manipulator 104 in response to receiving the start signal 1802. The activation signal 1202 indicating the drilling operation 110 is initiated.

In another further example, positioning of the machine drill tool 118 to the predetermined location 111 is controlled by a first numerical control program 1804 at the first robotic manipulator 112. In an even yet further example, the positioning of the machine drill tool 118 to the predetermined location 111 is further controlled by the first robotic manipulator 112 in response to a first proximity signal 1808 from a first proximity sensor 1806 installed on the first nosepiece assembly 1302 to detect the drilling side 114 of the workpiece 108.

In yet another further example, positioning of the machine drill tool 118 to the predetermined location 111 by the first robotic manipulator 112 includes aligning the first nosepiece assembly 1302 with the drilling side 114 of the workpiece 108 and applying a force on the drilling side 114 of the workpiece 108 via the machine drill tool 118 to surround the predetermined location 111 with the first nosepiece assembly 1302 to prepare for the drilling operation 110 and collection of the remnants 200 from the drilling operation 110.

In still another further example, the first robotic manipulator 112 is configured to provide a first displacement signal 1210 to the second robotic manipulator 104 in response to detecting the first displacement signal 1210 from a displacement sensor 1212 of the machine drill tool 118 indicating a first predetermined position of the machine drill tool 118 after initiation of the drilling operation 110, the first predetermined position associated with a first time prior to a drill bit 1424 on the machine drill tool 118 engaging with the drilling side 114 of the workpiece 108 at which the vacuum assembly 116 is to be activated, the second robotic manipulator 104 configured to apply the vacuum 902 to the exit side 106 of the workpiece 108 in response to receiving the first displacement signal 1210. In an even further example, the first robotic manipulator 112 is configured to provide a second displacement signal 1214 to the second robotic manipulator 104 in response to detecting the second displacement signal 1214 from the displacement sensor 1212 indicating a second predetermined position of the machine drill tool 118 after completion of the drilling operation 110. The second predetermined position is associated with a second time after which the vacuum assembly 116 is to be deactivated. The second robotic manipulator 104 configured to stop applying the vacuum 902 to the exit side 106 of the workpiece 108 in response to receiving the second displacement signal 1214.

In still yet another example of the robotic manufacturing system 1300, the second robotic manipulator 104 is configured to position the remnant extraction tool 100 to the predetermined location 111 on the workpiece 108 in response to an activation signal 1202 from the first robotic manipulator 112 indicating the drilling operation 110 is initiated. In a further example, positioning of the remnant extraction tool 100 to the predetermined location 111 is controlled by a second numerical control program 1204 at the second robotic manipulator 104. In an even further example, the positioning of the remnant extraction tool 100 to the predetermined location 111 is further controlled by the second robotic manipulator 104 in response to a second proximity signal 1206 from a second proximity sensor 1208 installed on the second nosepiece assembly 102 to detect the exit side 106 of the workpiece 108. In another further example, positioning of the remnant extraction tool 100 to the predetermined location 111 by the second robotic manipulator 104 includes aligning the second nosepiece assembly 102 with the exit side 106 of the workpiece 108 and applying a force on the exit side 106 of the workpiece 108 via the remnant extraction tool 100 to surround the predetermined location 111 with the second nosepiece assembly 102 to prepare for the drilling operation 110 and collection of the remnants 200 from the drilling operation 110.

In yet another further example, the second robotic manipulator 104 is configured to apply the vacuum 902 to the exit side 106 of the workpiece 108 in response to a first displacement signal 1210 from a displacement sensor 1212 of a machine drill tool 118 of the first robotic manipulator 112 indicating a first predetermined position of the machine drill tool 118 after initiation of the drilling operation 110. The first predetermined position associated with a first time prior to a drill bit 1424 on the machine drill tool 118 engaging with the drilling side 114 of the workpiece 108 at which the vacuum assembly 116 is to be activated. In an even further example, the second robotic manipulator 104 is configured to stop applying the vacuum 902 to the exit side 106 of the workpiece 108 in response to a second displacement signal 1214 from the displacement sensor 1212 indicating a second predetermined position of the machine drill tool 118 after completion of the drilling operation 110. The second predetermined position is associated with a second time after which the vacuum assembly 116 is to be deactivated.

In another even further example, the second nosepiece assembly 102 including an image sensor 1216 oriented to selectively capture images 1218 of the predetermined location 111 at the exit side 106 of the workpiece 108 during the drilling operation 110. In an even yet further example, the image sensor 1216 includes a digital video camera, a digital camera, a charge-coupled device, an active-pixel device, an optical scanner, a laser scanner or any other suitable image sensor in any suitable combination. In another even yet further example, the second robotic manipulator 104 is configured to receive the images 1218 from the image sensor 1216, to analyze the images 1218 and to stop applying the vacuum 902 to the exit side 106 of the workpiece 108 in response to detecting the drilling operation 110 is complete based on the images 1218 from the image sensor 1216. In yet another even yet further example, the second robotic manipulator 104 is configured to receive the images 1218 from the image sensor 1216, to analyze the images 1218 and to inspect results of the drilling operation 110 based on the images 1218 from the image sensor 1216.

Referring generally to FIGS. 1-6, 9, 12-15 and 18-26, by way of examples, the present disclosure is directed to a method 1900, 2000, 2200, 2300, 2500, 2600 for extracting remnants 200 during a drilling operation 110 at a robotic manufacturing system 1300. FIG. 1 is a side view of an example of a remnant extraction tool 100. FIG. 2 is a top view of examples of remnants 200 from drilling operations 110. FIG. 3 is a side view of an example of a workpiece 108 for a drilling operation 110. FIG. 4 is a perspective view of another example of a workpiece 108 that includes a stiffener joint 404 and a spar web 406. FIG. 5 is a perspective view of yet another example of a workpiece 108 that includes a spar web 406 and a rib post joint 502. FIG. 6 is an exploded view of an example of a nosepiece assembly 102 for the remnant extraction tool 100 of FIG. 1. FIG. 9 is a functional block diagram of yet another example of a remnant extraction tool 100. FIG. 12 is a functional block diagram of yet another example of a remnant extraction tool 100. FIG. 13 is a functional block diagram of an example of a robotic manufacturing system 1300. FIG. 14 is an exploded view of an example of a first nosepiece assembly 1302 in a machine drill tool 118 for the robotic manufacturing system 1300 of FIG. 13. FIG. 15 is a functional block diagram of an example of a machine drill tool 118 for the robotic manufacturing system 1300 of FIG. 13. FIG. 16 is a functional diagram of another example of a machine drill tool 118 with a portion of the first nosepiece assembly 1302 of FIG. 14 shown in cross-section. FIG. 18 is a functional block diagram of another example of a robotic manufacturing system 1300.

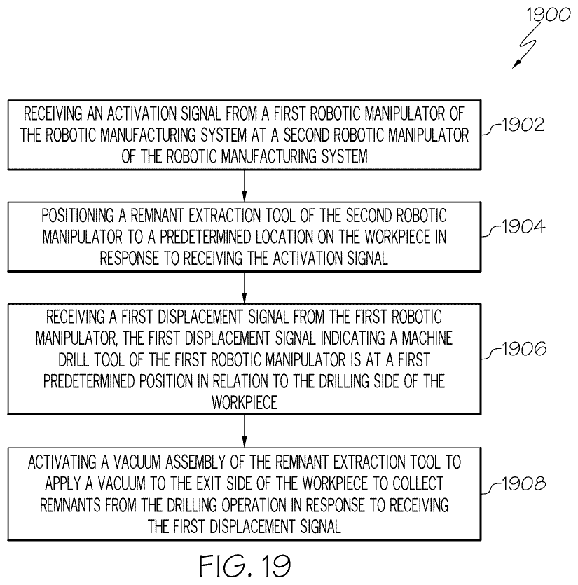

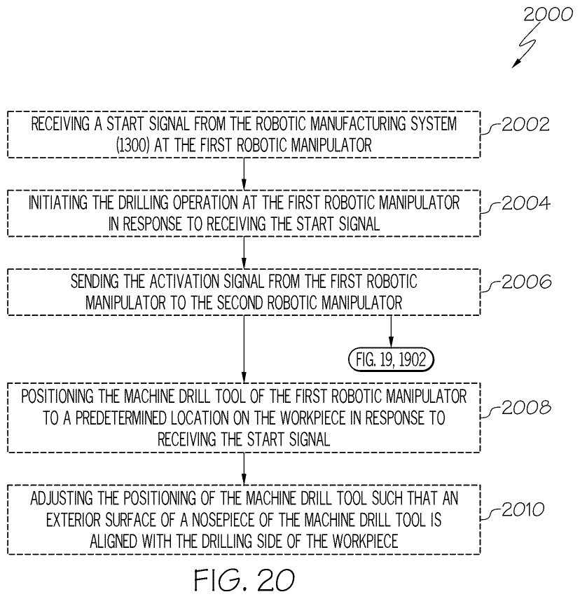

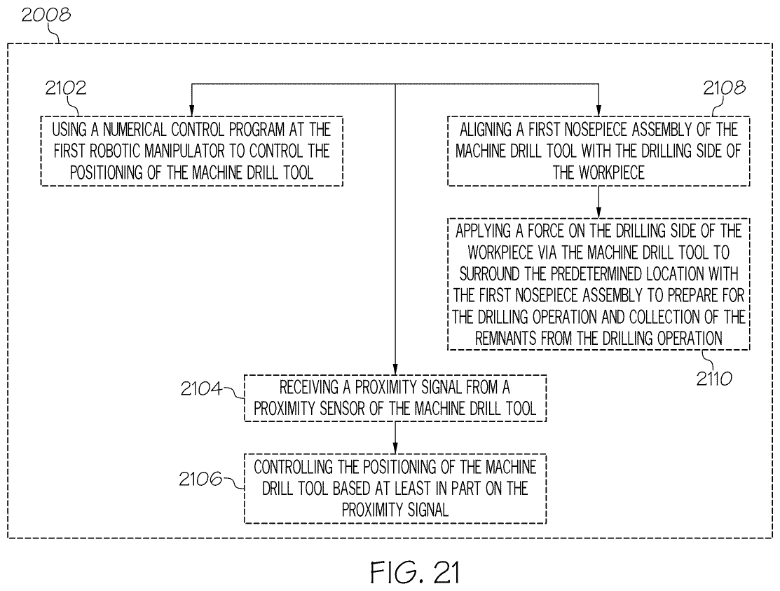

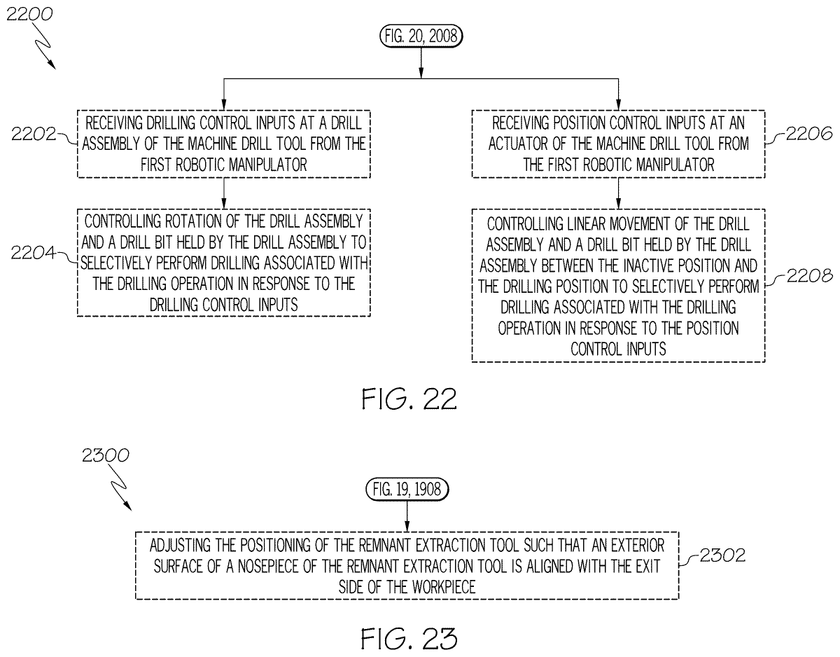

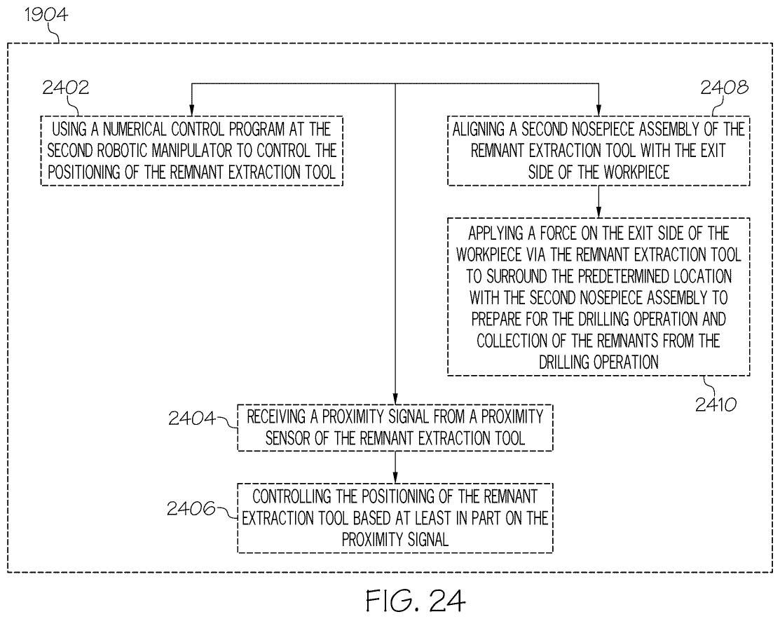

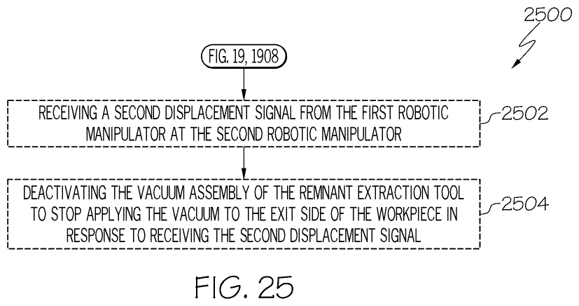

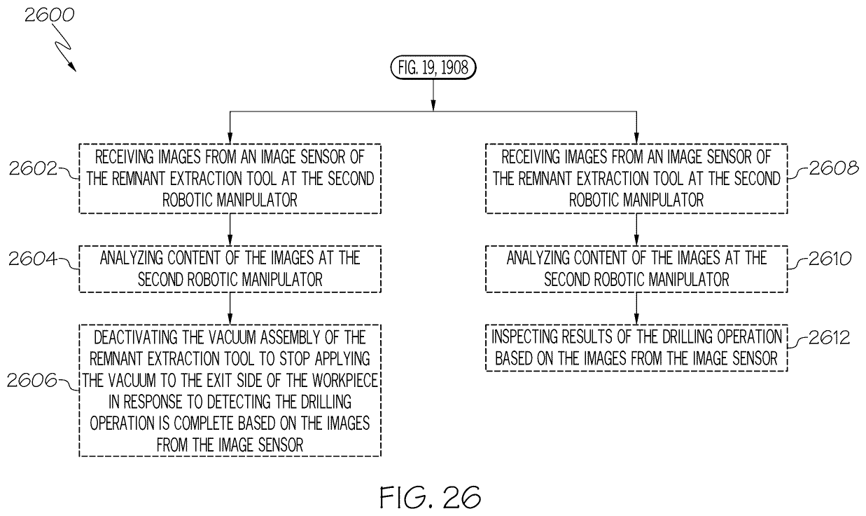

FIG. 19 provides an example of the method 1900 for extracting remnants 200 during a drilling operation 110 at a robotic manufacturing system 1300. FIG. 20, in combination with FIG. 19, provides an example of the method 2000 for extracting remnants 200 during a drilling operation 110 at a robotic manufacturing system1300. FIG. 21 provides an example of the positioning 2008 of the machine drill tool 118 in the method 2000 of FIG. 20. FIG. 22, in combination with FIGS. 19 and 20, provides an example of the method 2200 for extracting remnants 200 during a drilling operation 110 at a robotic manufacturing system 1300. FIG. 23, in combination with FIG. 19, provides an example of the method 2300 for extracting remnants 200 during a drilling operation 110 at a robotic manufacturing system 1300. FIG. 24 provides an example of the positioning 1904 of the remnant extraction tool 100 in the method 1900 of FIG. 19. FIG. 25, in combination with FIG. 19, provides an example of the method 2500 for extracting remnants 200 during a drilling operation 110 at a robotic manufacturing system 1300. FIG. 26, in combination with FIG. 19, provides an example of the method 2600 for extracting remnants 200 during a drilling operation 110 at a robotic manufacturing system 1300.

With reference again to FIGS. 1-5, 12-14 and 19, in one or more example, a method 1900 (see FIG. 19) for extracting remnants 200 during a drilling operation 110 at a robotic manufacturing system 1300 includes receiving 1902 an activation signal 1202 from a first robotic manipulator 112 of the robotic manufacturing system 1300 at a second robotic manipulator 104 of the robotic manufacturing system 1300. The first robotic manipulator 112 disposed on a drilling side 114 of a workpiece 108. The second robotic manipulator 104 disposed on an exit side 106 of the workpiece 108. The activation signal 1202 indicating the drilling operation 110 is initiated. At 1904, a remnant extraction tool 100 of the second robotic manipulator 104 is positioned to a predetermined location 111 on the workpiece 108 in response to receiving the activation signal 1202. At 1906, a first displacement signal 1210 is received from the first robotic manipulator 112. The first displacement signal 1210 indicating a machine drill tool 118 of the first robotic manipulator 112 is at a first predetermined position in relation to the drilling side 114 of the workpiece 108. The first predetermined position indicating a drill bit 1424 in the machine drill tool 118 is approaching the drilling side 114 of the workpiece 108. At 1908, a vacuum assembly 116 of the remnant extraction tool 100 is activated to apply a vacuum 902 to the exit side 106 of the workpiece 108 to collect remnants 200 from the drilling operation 110 in response to receiving the first displacement signal 1210.

In another example of the method 1900, the workpiece 108 includes a first material component 302 and a second material component 304. In a further example, the workpiece 108 includes a previously drilled hole 306 through the first material component 302 and the second material component 304, and a fastener 308 installed in the previously drilled hole 306. In an even further example, the fastener 308 includes a metallic material, an aluminum material, an aluminum alloy material or any other suitable material in any suitable combination. In another even further example, the fastener 308 includes a tack fastener 402. In yet another further example, the drilling operation 110 includes drilling out the fastener 308.

In another further example, the first material component 302 includes a stiffener joint 404, and the second material component 304 includes a spar web 406 for an aircraft wing. In yet another further example, the first material component 302 includes a spar web 406 for an aircraft wing and the second material component 304 includes a rib post joint 502.

With reference again to FIGS. 1, 13 and 18-21, in one or more example, a method 2000 (see FIG. 20) for extracting remnants 200 during a drilling operation 110 at a robotic manufacturing system 1300 includes the method 1900 of FIG. 19. In this example, the method 2000 includes receiving 2002 a start signal 1802 from the robotic manufacturing system 1300 at the first robotic manipulator 112. The start signal 1802 indicating the drilling operation 110 is to be initiated. At 2004, the drilling operation 110 is initiated at the first robotic manipulator 112 in response to receiving the start signal 1802. At 2006, the activation signal 1202 is sent from the first robotic manipulator 112 to the second robotic manipulator 104. The method 2000 continues from 2006 to 1902 of FIG. 19. Additionally, at 2008, the machine drill tool 118 of the first robotic manipulator 112 is positioned to the predetermined location 111 on the workpiece 108 in response to receiving the start signal 1802.

In another example, the method 2000 also includes adjusting 2010 the positioning of the machine drill tool 118 such that an exterior surface 1412 of a first nosepiece 1402 of the machine drill tool 118 is aligned with the drilling side 114 of the workpiece 108. In yet another example of the method 2000, the positioning 2008 of the machine drill tool 118 includes using 2102 a first numerical control program 1804 at the first robotic manipulator 112 to control the positioning of the machine drill tool 118. In still another example of the method 2000, the positioning 2008 of the machine drill tool 118 includes receiving 2104 a first proximity signal 1808 from a first proximity sensor 1806 of the machine drill tool 118. The first proximity sensor 1806 configured to detect the drilling side 114 of the workpiece 108. At 2106, the positioning of the machine drill tool 118 is controlled based at least in part on the first proximity signal 1808. In still yet another example of the method 2000, the positioning 2008 of the machine drill tool 118 includes aligning 2108 a first nosepiece assembly 1302 of the machine drill tool 118 with the drilling side 114 of the workpiece 108. At 2110, a force is applied on the drilling side 114 of the workpiece 108 via the machine drill tool 118 to surround the predetermined location 111 with the first nosepiece assembly 1302 to prepare for the drilling operation 110 and collection of the remnants 200 from the drilling operation 110.

With reference again to FIGS. 1, 13-15, 19, 20 and 22, in one or more example, a method 2200 (see FIG. 22) for extracting remnants 200 during a drilling operation 110 at a robotic manufacturing system 1300 includes the method 1900 of FIG. 19 and the method 2000 of FIG. 20 and continues from 2008 to 2202 where drilling control inputs 1506 are received at a drill assembly 1422 of the machine drill tool 118 from the first robotic manipulator 112. At 2204, rotation of the drill assembly 1422 and a drill bit 1424 held by the drill assembly 1422 is controlled to selectively perform drilling associated with the drilling operation 110 in response to the drilling control inputs 1506. In this example, the method 2200 also continues from 2008 to 2206 where position control inputs 1508 are received at an actuator 1426 of the machine drill tool 118 from the first robotic manipulator 112. The actuator 1426 mechanically linked to a central housing member 1414 with a longitudinal cavity 1420 and a drill assembly 1422 of the machine drill tool 118. The drill assembly 1422 movable within the longitudinal cavity 1420 between an inactive position 1502 and a drilling position 1504. At 2208, linear movement of the drill assembly 1422 and a drill bit 1424 held by the drill assembly 1422 is controlled between the inactive position 1502 and the drilling position 1504 to selectively perform drilling associated with the drilling operation 110 in response to the position control inputs 1508.

With reference again to FIGS. 1, 2, 6, 12, 19, 23 and 24, in one or more example, a method 2300 (see FIG. 23) for extracting remnants 200 during a drilling operation 110 at a robotic manufacturing system 1300 includes the method 1900 of FIG. 19 and continues from 1908 to 2302 where the positioning of the remnant extraction tool 100 is adjusted such that an exterior surface 612 of a second nosepiece 602 of the remnant extraction tool 100 is aligned with the exit side 106 of the workpiece 108. In another example of the method 2300, the positioning 1904 of the remnant extraction tool 100 includes using 2402 a second numerical control program 1204 at the second robotic manipulator 104 to control the positioning of the remnant extraction tool 100. In yet another example of the method 2300, the positioning 1908 of the remnant extraction tool 100 includes receiving 2404 a second proximity signal 1206 from a second proximity sensor 1208 of the remnant extraction tool 100. The second proximity sensor 1208 configured to detect the exit side 106 of the workpiece 108. At 2406, the positioning of the remnant extraction tool 100 is controlled based at least in part on the second proximity signal 1206. In still another example of the method 2300, the positioning 1908 of the remnant extraction tool 100 includes aligning 2408 a second nosepiece assembly 102 of the remnant extraction tool 100 with the exit side 106 of the workpiece 108. At 2410, a force is applied on the exit side 106 of the workpiece 108 via the remnant extraction tool 100 to surround the predetermined location 111 with the second nosepiece assembly 102 to prepare for the drilling operation 110 and collection of the remnants 200 from the drilling operation 110.

With reference again to FIGS. 1, 9, 12, 19 and 25, in one or more example, a method 2500 (see FIG. 25) for extracting remnants 200 during a drilling operation 110 at a robotic manufacturing system 1300 includes the method 1900 of FIG. 19 and continues from 1908 to 2502 where a second displacement signal 1214 is received from the first robotic manipulator 112 at the second robotic manipulator 104. The second displacement signal 1214 indicating the machine drill tool 118 is at a second predetermined position in relation to the drilling side 114 of the workpiece 108. The second predetermined position indicating the drilling operation 110 is complete. At 2504, the vacuum assembly 116 of the remnant extraction tool 100 is deactivated to stop applying the vacuum 902 to the exit side 106 of the workpiece 108 in response to receiving the second displacement signal 1214.

With reference again to FIGS. 1, 9, 12, 19 and 26, in one or more example, a method 2600 (see FIG. 26) for extracting remnants 200 during a drilling operation 110 at a robotic manufacturing system 1300 includes the method 1900 of FIG. 19 and continues from 1908 to 2602 where images 1218 are received from an image sensor 1216 of the remnant extraction tool 100 at the second robotic manipulator 104. The image sensor 1216 oriented to selectively capture images 1218 of the predetermined location 111 at the exit side 106 of the workpiece 108 during the drilling operation 110. At 2604, content of the images 1218 is analyzed at the second robotic manipulator 104. At 2606, the vacuum assembly 116 of the remnant extraction tool 100 is deactivated to stop applying the vacuum 902 to the exit side 106 of the workpiece 108 in response to detecting the drilling operation 110 is complete based on the images 1218 from the image sensor 1216. The method 2600 also continues from 1908 to 2608 where images 1218 are received from an image sensor 1216 of the remnant extraction tool 100 at the second robotic manipulator 104. The image sensor 1216 oriented to selectively capture images 1218 of the predetermined location 111 at the exit side 106 of the workpiece 108 during the drilling operation 110. At 2610, content of the images 1218 is analyzed at the second robotic manipulator 104. At 2612, results of the drilling operation 110 are inspected based on the images 1218 from the image sensor 1216.

Examples of remnant extraction tools 100, robotic manufacturing systems 1300 and methods 1900, 2000, 2200, 2300, 2500, 2600 for extracting remnants 200 during drilling operations 110 at robotic manufacturing systems 1300 may be related to or used in the context of aircraft manufacturing. Although an aircraft example is described, the examples and principles disclosed herein may be applied to other products in the aerospace industry and other industries, such as the automotive industry, the space industry, the construction industry and other design and manufacturing industries. Accordingly, in addition to aircraft, the examples and principles disclosed herein may apply to the use of various products in the manufacture of various types of vehicles and in the construction of various types of buildings.

The preceding detailed description refers to the accompanying drawings, which illustrate specific examples described by the present disclosure. Other examples having different structures and operations do not depart from the scope of the present disclosure. Like reference numerals may refer to the same feature, element, or component in the different drawings. Throughout the present disclosure, any one of a plurality of items may be referred to individually as the item and a plurality of items may be referred to collectively as the items and may be referred to with like reference numerals. Moreover, as used herein, a feature, element, component, or step preceded with the word “a” or “an” should be understood as not excluding a plurality of features, elements, components, or steps, unless such exclusion is explicitly recited.

Illustrative, non-exhaustive examples, which may be, but are not necessarily, claimed, of the subject matter according to the present disclosure are provided above. Reference herein to “example” means that one or more feature, structure, element, component, characteristic and/or operational step described in connection with the example is included in at least one aspect, embodiment and/or implementation of the subject matter according to the present disclosure. Thus, the phrases “an example,” “another example,” “one or more example,” and similar language throughout the present disclosure may, but do not necessarily, refer to the same example. Further, the subject matter characterizing any one example may, but does not necessarily, include the subject matter characterizing any other example. Moreover, the subject matter characterizing any one example may be, but is not necessarily, combined with the subject matter characterizing any other example.

As used herein, a system, apparatus, device, structure, article, element, component, or hardware “configured to” perform a specified function is indeed capable of performing the specified function without any alteration, rather than merely having potential to perform the specified function after further modification. In other words, the system, apparatus, device, structure, article, element, component, or hardware “configured to” perform a specified function is specifically selected, created, implemented, utilized, programmed and/or designed for the purpose of performing the specified function. As used herein, “configured to” denotes existing characteristics of a system, apparatus, structure, article, element, component, or hardware that enable the system, apparatus, structure, article, element, component, or hardware to perform the specified function without further modification. For purposes of this disclosure, a system, apparatus, device, structure, article, element, component, or hardware described as being “configured to” perform a particular function may additionally or alternatively be described as being “adapted to” and/or as being “operative to” perform that function.

Unless otherwise indicated, the terms “first,” “second,” “third,” etc., are used herein merely as labels and are not intended to impose ordinal, positional, or hierarchical requirements on the items to which these terms refer. Moreover, reference to, e.g., a “second” item does not require or preclude the existence of, e.g., a “first” or lower-numbered item and/or, e.g., a “third” or higher-numbered item.

As used herein, the phrase “at least one of,” when used with a list of items, means different combinations of one or more of the listed items may be used and only one of each item in the list may be needed. For example, “at least one of item A, item B and item C” may include, without limitation, item A or item A and item B. This example also may include item A, item B and item C or item B and item C. In other examples, “at least one of” may be, for example, without limitation, two of item A, one of item B and ten of item C; four of item B and seven of item C; and other suitable combinations. As used herein, the term “and/or” and the “/” symbol includes any and all combinations of one or more of the associated listed items.

As used herein, the terms “coupled,” “coupling,” and similar terms refer to two or more elements that are joined, linked, fastened, attached, connected, put in communication, or otherwise associated (e.g., mechanically, electrically, fluidly, optically, electromagnetically) with one another. In various examples, the elements may be associated directly or indirectly. As an example, element A may be directly associated with element B. As another example, element A may be indirectly associated with element B, for example, via another element C. It will be understood that not all associations among the various disclosed elements are necessarily represented. Accordingly, couplings other than those depicted in the figures may also exist.

As used herein, the term “approximately” refers to or represents a condition that is close to, but not exactly, the stated condition that still performs the desired function or achieves the desired result. As an example, the term “approximately” refers to a condition that is within an acceptable predetermined tolerance or accuracy, such as to a condition that is within 10% of the stated condition. However, the term “approximately” does not exclude a condition that is exactly the stated condition. As used herein, the term “substantially” refers to a condition that is essentially the stated condition that performs the desired function or achieves the desired result.

In FIGS. 1-18, referred to above, may represent functional elements, features, or components thereof and do not necessarily imply any particular structure. Accordingly, modifications, additions and/or omissions may be made to the illustrated structure. Additionally, those skilled in the art will appreciate that not all elements, features and/or components described and illustrated in FIGS. 1-18, referred to above, need be included in every example and not all elements, features and/or components described herein are necessarily depicted in each illustrative example. Accordingly, some of the elements, features and/or components described and illustrated in FIGS. 1-18 may be combined in various ways without the need to include other features described and illustrated in FIGS. 1-18, other drawing figures and/or the accompanying disclosure, even though such combination or combinations are not explicitly illustrated herein. Similarly, additional features not limited to the examples presented, may be combined with some or all the features shown and described herein. Unless otherwise explicitly stated, the schematic illustrations of the examples depicted in FIGS. 1-18, referred to above, are not meant to imply structural limitations with respect to the illustrative example. Rather, although one illustrative structure is indicated, it is to be understood that the structure may be modified when appropriate. Accordingly, modifications, additions and/or omissions may be made to the illustrated structure. Furthermore, elements, features and/or components that serve a similar, or at least substantially similar, purpose are labeled with like numbers in each of FIGS. 1-18 and such elements, features and/or components may not be discussed in detail herein with reference to each of FIGS. 1-18. Similarly, all elements, features and/or components may not be labeled in each of FIGS. 1-18, but reference numerals associated therewith may be utilized herein for consistency.

In FIGS. 19-26, referred to above, the blocks may represent operations, steps and/or portions thereof, and lines connecting the various blocks do not imply any particular order or dependency of the operations or portions thereof. It will be understood that not all dependencies among the various disclosed operations are necessarily represented. FIGS. 19-26 and the accompanying disclosure describing the operations of the disclosed methods set forth herein should not be interpreted as necessarily determining a sequence in which the operations are to be performed. Rather, although one illustrative order is indicated, it is to be understood that the sequence of the operations may be modified when appropriate. Accordingly, modifications, additions and/or omissions may be made to the operations illustrated and certain operations may be performed in a different order or simultaneously. Additionally, those skilled in the art will appreciate that not all operations described need to be performed.

Further, references throughout the present specification to features, advantages, or similar language used herein do not imply that all the features and advantages that may be realized with the examples disclosed herein should be, or are in, any single example. Rather, language referring to the features and advantages is understood to mean that a specific feature, advantage, or characteristic described in connection with an example is included in at least one example. Thus, discussion of features, advantages and similar language used throughout the present disclosure may, but does not necessarily, refer to the same example.

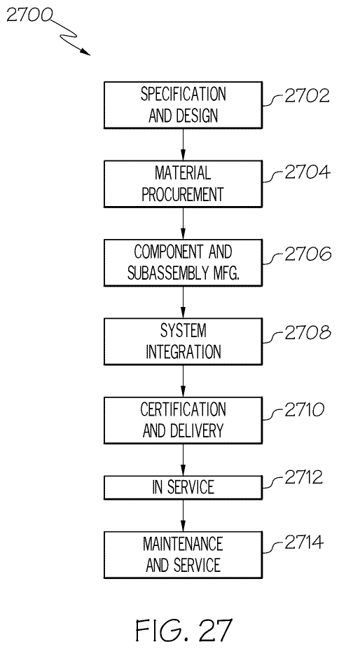

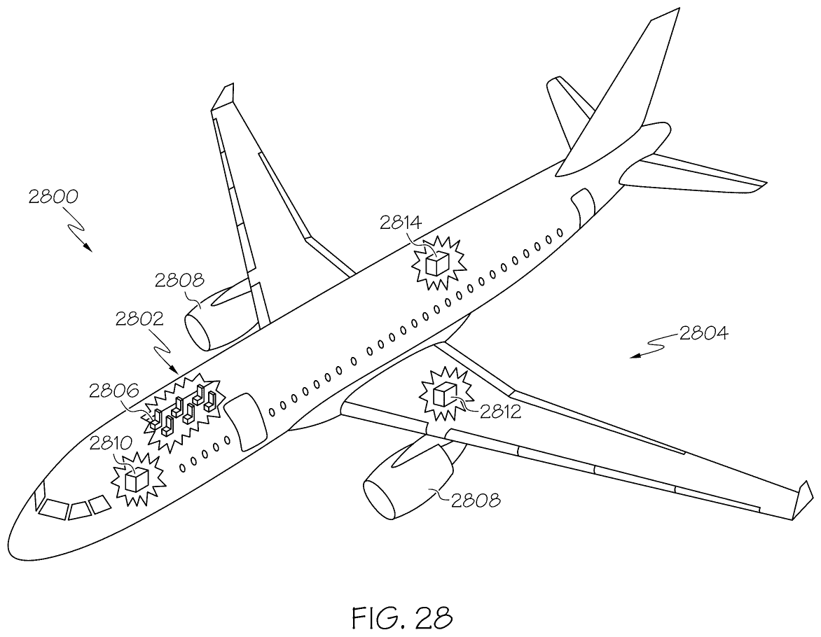

Examples of the subject matter disclosed herein may be described in the context of aircraft manufacturing and service method 2700 as shown in FIG. 27 and aircraft 2800 as shown in FIG. 28. In one or more example, the disclosed remnant extraction tools 100, robotic manufacturing systems 1300 and methods 1900, 2000, 2200, 2300, 2500, 2600 for extracting remnants 200 during drilling operations 110 at robotic manufacturing systems 1300 may be used in aircraft manufacturing. During pre-production, the service method 2700 may include specification and design (block 2702) of aircraft 2800 and material procurement (block 2704). During production, component and subassembly manufacturing (block 2706) and system integration (block 2708) of aircraft 2800 may take place. Thereafter, aircraft 2800 may go through certification and delivery (block 2710) to be placed in service (block 2712). While in service, aircraft 2800 may be scheduled for routine maintenance and service (block 2714). Routine maintenance and service may include modification, reconfiguration, refurbishment, etc. of one or more systems of aircraft 2800.

Each of the processes of the service method 2700 may be performed or carried out by a system integrator, a third party and/or an operator (e.g., a customer). For the purposes of this description, a system integrator may include, without limitation, any number of aircraft manufacturers and major-system subcontractors; a third party may include, without limitation, any number of vendors, subcontractors and suppliers; and an operator may be an airline, leasing company, military entity, service organization and so on.

As shown in FIG. 28, aircraft 2800 produced by the service method 2700 may include airframe 2802 with a plurality of high-level systems 2804 and interior 2806. Examples of high-level systems 2804 include one or more of propulsion system 2808, electrical system 2810, hydraulic system 2812 and environmental system 2814. Any number of other systems may be included. Although an aerospace example is shown, the principles disclosed herein may be applied to other industries, such as the automotive industry. Accordingly, in addition to aircraft 2800, the principles disclosed herein may apply to other vehicles, e.g., land vehicles, marine vehicles, space vehicles, etc.

The disclosed remnant extraction tools 100, robotic manufacturing systems 1300 and methods 1900, 2000, 2200, 2300, 2500, 2600 for extracting remnants 200 during drilling operations 110 at robotic manufacturing systems 1300 may be employed during any one or more of the stages of the manufacturing and service method 2700. For example, components or subassemblies corresponding to component and subassembly manufacturing (block 2706) may be fabricated or manufactured in a manner similar to components or subassemblies produced while aircraft 2800 is in service (block 2712). Also, one or more example of the system(s), method(s), or combination thereof may be utilized during production stages (block 2706 and block 2708), for example, by substantially expediting assembly of or reducing the cost of aircraft 2800. Similarly, one or more example of the system or method realizations, or a combination thereof, may be utilized, for example and without limitation, while aircraft 2800 is in service (block 2712) and/or during maintenance and service (block 2714).

The described features, advantages and characteristics of one example may be combined in any suitable manner in one or more other examples. One skilled in the relevant art will recognize that the examples described herein may be practiced without one or more of the specific features or advantages of a particular example. In other instances, additional features and advantages may be recognized in certain examples that may not be present in all examples. Furthermore, various examples of the remnant extraction tools 100, robotic manufacturing systems 1300 and methods 1900, 2000, 2200, 2300, 2500, 2600 for extracting remnants 200 during drilling operations 110 at robotic manufacturing systems 1300 have been shown and described, modifications may occur to those skilled in the art upon reading the specification. The present application includes such modifications and is limited only by the scope of the claims.

1. A remnant extraction tool, comprising:
a nosepiece assembly configured to engage with a robotic manipulator and configured to adjustably align with an exit side of a workpiece during a drilling operation through the workpiece at a predetermined location, the drilling operation includes drilling performed by another robotic manipulator from a drilling side of the workpiece; and
a vacuum assembly in fluidic communication with the nosepiece assembly and configured to engage with the robotic manipulator for operative communication to selectively apply a vacuum to the exit side of the workpiece via the nosepiece assembly and to collect remnants from the drilling operation.

2. The remnant extraction tool of claim 1 wherein the robotic manipulator comprises at least one of a robotic arm, an articulated robotic arm, a 4-axis robotic arm, a 6-axis robotic arm and a collaborative robot.

3. The remnant extraction tool of claim 1 wherein the workpiece comprises a first material component and a second material component.

4. The remnant extraction tool of claim 3 wherein the workpiece comprises a previously drilled hole through the first material component and the second material component, and a fastener installed in the previously drilled hole.

5-7. (canceled)

8. The remnant extraction tool of claim 3 wherein the first material component comprises at least one of a metallic material, an aluminum material, an aluminum alloy material, a polymeric composite material, a thermoplastic composite material and a thermoset composite material.

9. The remnant extraction tool of claim 3 wherein the second material component comprises at least one of a metallic material, an aluminum material, an aluminum alloy material, a polymeric composite material, a thermoplastic composite material and a thermoset composite material.

10. The remnant extraction tool of claim 3 wherein the first material component comprises a stiffener joint, and the second material component comprises a spar web for an aircraft wing.

11. The remnant extraction tool of claim 3 wherein the first material component comprises a spar web for an aircraft wing and the second material component comprises a rib post joint.

12. The remnant extraction tool of claim 1 wherein the another robotic manipulator comprises at least one of a robotic arm, an articulated robotic arm, a 4-axis robotic arm, a 6-axis robotic arm and a collaborative robot.

13. The remnant extraction tool of claim 1, the nosepiece assembly comprising:
a nosepiece comprising a body with an aperture extending from a first distal end to a first proximal end and an exterior surface at the first distal end, the nosepiece configured to adjustably align the exterior surface with the exit side of the workpiece during the drilling operation;
a nosepiece extension with a second distal end and a second proximal end and comprising a concave cavity at the second distal end that receives the nosepiece, the nosepiece extension also comprising at least one ambient air input vent, a channel and a vacuum port, the at least one ambient air input vent open to receive ambient air, the channel in fluidic communication with the aperture and the at least one ambient air input vent, the vacuum port in fluidic communication with the channel and the vacuum assembly; and
a foot mount member installed on the second proximal end of the nosepiece extension and configured to engage with the robotic manipulator.

14. (canceled)

15. The remnant extraction tool of claim 1, the vacuum assembly comprising:
a first vacuum line connected to the nosepiece assembly and in fluidic communication with the exit side of the workpiece and at least one ambient air input vent via the nosepiece assembly during the drilling operation;
a vacuum generator in fluidic communication with the nosepiece assembly via the first vacuum line and configured to engage with the robotic manipulator for operative communication;
a second vacuum line connected to the vacuum generator; and
a waste container connected to the second vacuum line and configured for installation on the robotic manipulator.

16-17. (canceled)

18. The remnant extraction tool of claim 15, the vacuum generator comprising:
a venturi vacuum assembly with a pressurized pneumatic input port in operative communication with a pressurized air source via a solenoid switch operated by the robotic manipulator and configured to provide pressurized air to the venturi vacuum assembly via a pressurized air line, the pressurized air creates a venturi effect in conjunction with ambient air flowing in the at least one ambient air input vent to generate the vacuum during the drilling operation, the venturi vacuum assembly further comprising a vacuum suction port in fluidic communication with the exit side of the workpiece via the nosepiece assembly and the first vacuum line and configured to provide the vacuum to the exit side during the drilling operation, the venturi vacuum assembly further comprising a vacuum exhaust port in fluidic communication with the waste container via the second vacuum line and configured to collect remnants from the drilling operation.

19. (canceled)

20. The remnant extraction tool of claim 1 wherein the robotic manipulator is configured to position the remnant extraction tool to the predetermined location on the workpiece in response to an activation signal from the another robotic manipulator indicating the drilling operation is initiated.

21. The remnant extraction tool of claim 20 wherein positioning of the remnant extraction tool to the predetermined location is controlled by a numerical control program at the robotic manipulator.

22. (canceled)

23. The remnant extraction tool of claim 20 wherein positioning of the remnant extraction tool to the predetermined location by the robotic manipulator comprises aligning the nosepiece assembly with the exit side of the workpiece and applying a force on the exit side of the workpiece via the remnant extraction tool to surround the predetermined location with the nosepiece assembly to prepare for the drilling operation and collection of the remnants from the drilling operation.

24. The remnant extraction tool of claim 20 wherein the robotic manipulator is configured to apply the vacuum to the exit side of the workpiece in response to a first displacement signal from a displacement sensor of a machine drill tool of the another robotic manipulator indicating a first predetermined position of the machine drill tool after initiation of the drilling operation, the first predetermined position associated with a first time prior to a drill bit on the machine drill tool engaging with the drilling side of the workpiece at which the vacuum assembly is to be activated.

25. The remnant extraction tool of claim 24 wherein the robotic manipulator is configured to stop applying the vacuum to the exit side of the workpiece in response to a second displacement signal from the displacement sensor indicating a second predetermined position of the machine drill tool after completion of the drilling operation, the second predetermined position associated with a second time after which the vacuum assembly is to be deactivated.

26. The remnant extraction tool of claim 24, the nosepiece assembly comprising:
an image sensor oriented to selectively capture images of the predetermined location at the exit side of the workpiece during the drilling operation.

27-29. (canceled)

30. A robotic manufacturing system, comprising:
a machine drill tool for a first robotic manipulator of the robotic manufacturing system, the machine drill tool comprising:
a first nosepiece assembly configured to adjustably align with a drilling side of a workpiece during a drilling operation by the robotic manufacturing system, the first nosepiece assembly configured to engage with the first robotic manipulator for operative communication to selectively drill a hole through the workpiece at a predetermined location during the drilling operation;
a remnant extraction tool for a second robotic manipulator of the robotic manufacturing system, the remnant extraction tool comprising:
a second nosepiece assembly configured to adjustably align with an exit side of the workpiece in conjunction with the drilling operation, the second nosepiece assembly configured to engage with the second robotic manipulator; and
a vacuum assembly in fluidic communication with the second nosepiece assembly and configured to engage with the second robotic manipulator for operative communication to selectively apply a vacuum to the exit side of the workpiece via the second nosepiece assembly and to collect remnants from the drilling operation.

31-69. (canceled)

70. A method for extracting remnants during a drilling operation at a robotic manufacturing system, the method comprising:
receiving an activation signal from a first robotic manipulator of the robotic manufacturing system at a second robotic manipulator of the robotic manufacturing system, the first robotic manipulator disposed on a drilling side of a workpiece, the second robotic manipulator disposed on an exit side of the workpiece, the activation signal indicating the drilling operation is initiated;
positioning a remnant extraction tool of the second robotic manipulator to a predetermined location on the workpiece in response to receiving the activation signal;
receiving a first displacement signal from the first robotic manipulator, the first displacement signal indicating a machine drill tool of the first robotic manipulator is at a first predetermined position in relation to the drilling side of the workpiece, the first predetermined position indicating a drill bit in the machine drill tool is approaching the drilling side of the workpiece; and
activating a vacuum assembly of the remnant extraction tool to apply a vacuum to the exit side of the workpiece to collect remnants from the drilling operation in response to receiving the first displacement signal.

71-91. (canceled)
